(19) United States
(12) Patent Application Publication
(10) Pub. No.: US 2013/0050386 A1
(43) Pub. Date: Feb. 28, 2013

(54) LIGHT EMITTING UNIT AND IMAGE FORMING APPARATUS

(71) Applicants: Masahiro IGUSA, Kanagawa (JP); Roshan THAPLIYA, Kanagawa (JP); Takashi KIKUCHI, Kanagawa (JP)

(72) Inventors: Masahiro IGUSA, Kanagawa (JP); Roshan THAPLIYA, Kanagawa (JP); Takashi KIKUCHI, Kanagawa (JP)

(73) Assignee: FUJI XEROX CO., LTD., Tokyo (JP)

(21) Appl. No.: 13/345,356

(22) Filed: Jan. 6, 2012

(30) Foreign Application Priority Data
Aug. 31, 2011 (JP) 2011-189973

(51) Int. Cl. B41J 2/435; F21V 5/04

(52) U.S. Cl. 347/224; 362/244

(57) ABSTRACT

A light emitting unit includes a substrate, plural light emitting elements disposed on the substrate, and a lens array disposed above the plural light emitting elements. The lens array includes a base and plural lenses that each focus light emitted from a corresponding light emitting element among the plural light emitting elements. The base includes a boundary surface which is in contact with the plural lenses and an opposing surface which opposes the plural light emitting elements. The distance from one of the plural light emitting elements to the boundary surface of the base which is in contact with a corresponding lens among the plural lenses is different from the distance from another one of the plural light emitting elements to the boundary surface of the base which is in contact with a corresponding lens among the plural lenses.

### CROSS-REFERENCE TO RELATED APPLICATIONS

This application is based on and claims priority under 35 USC 119 from Japanese Patent Application No. 2011-189973 filed Aug. 31, 2011.

### BACKGROUND

(i) Technical Field

The present invention relates to light emitting units and image forming apparatuses.

(ii) Related Art

In a light emitting component, a lens (microlens or microbead) is disposed to face the light-emitting surface of a light emitting element so that light emitted from the light emitting surface of the light emitting element is focused in a predetermined direction and is efficiently extracted.

### SUMMARY

According to an aspect of the invention, there is provided a light emitting unit including a substrate, plural light emitting elements disposed on the substrate, and a lens array disposed above the plural light emitting elements. The lens array includes a base and plural lenses that each focus light emitted from a corresponding light emitting element among the plural light emitting elements. The base includes a boundary surface which is in contact with the plural lenses and an opposing surface which opposes the plural light emitting elements. The distance from one of the plural light emitting elements to the boundary surface of the base which is in contact with a corresponding lens among the plural lenses is different from the distance from another one of the plural light emitting elements to the boundary surface of the base which is in contact with a corresponding lens among the plural lenses.

### BRIEF DESCRIPTION OF THE DRAWINGS

Exemplary embodiment(s) of the present invention will be described in detail based on the following figures, wherein:

FIG. 1 illustrates an example of the overall configuration of an image forming apparatus according to a first exemplary embodiment of the invention;

FIG. 2 is a sectional view illustrating the configuration of a print head;

FIG. 3 is a top view illustrating a light emitting device;

FIGS. 4A and 4B respectively illustrate the configuration of a light emitting chip and the configuration of a signal generating circuit of the light emitting device and the configuration of wiring patterns (lines) on a circuit board of the light emitting device according to the first exemplary embodiment;

FIG. 5 is an equivalent circuit diagram illustrating the circuit configuration of a light emitting chip on which a single self-scanning light emitting device array (SLED) is mounted;

FIGS. 6A and 6B are respectively a plan view illustrating the layout of a light emitting chip according to the first exemplary embodiment and a sectional view taken along line VIB-VIB of FIG. 6A;

FIG. 7 illustrates lenses (bases and lens portions) provided on light emitting thyristors according to the first exemplary embodiment;

FIGS. 8A through 8E are sectional views illustrating a method for forming lenses (bases and lens portions) according to the first exemplary embodiment;

FIG. 9 is a timing chart illustrating operations of a light emitting device and a light emitting chip;

FIG. 10 illustrates the amounts of light of light emitting thyristors of a light emitting chip according to the first exemplary embodiment;

FIG. 11 illustrates an example of a change in the amount of light of a light emitting thyristor provided with a lens with respect to the height from a light emitting surface to the vertex of the lens;

FIGS. 12A and 12B are schematic views illustrating that the amount of light of a light emitting thyristor changes in accordance with the height from a light emitting surface to the vertex of the lens;

FIG. 13 illustrates lenses for which bases are provided such that they are gradually tilted;

FIGS. 14A and 14B illustrate examples of other configurations of lenses;

FIGS. 15A and 15B respectively illustrate the configuration of a light emitting chip and the configuration of a signal generating circuit of a light emitting device and the configuration of wiring patterns (lines) on a circuit board of the light emitting device according to a second exemplary embodiment;

FIG. 16 is an equivalent circuit diagram illustrating the circuit configuration of a light emitting chip on which two SLEDs are mounted according to the second exemplary embodiment;

FIG. 17 illustrates lenses (bases and lens portions) provided on light emitting thyristors according to the second exemplary embodiment; and

FIG. 18 illustrates the amounts of light of light emitting thyristors of a light emitting chip according to the second exemplary embodiment.

### DETAILED DESCRIPTION

In an image forming apparatus, such as a printer, a copying machine, or a facsimile utilizing an electrophotographic system, image formation is performed as follows. Image information is applied onto a charged photoconductor by using optical recording irradiation so as to obtain electrostatic latent images. Then, toner is applied to the electrostatic latent images to visualize images, and the visualized images are then transferred onto recording paper and are fixed. As the optical recording irradiation, laser is utilized, and scanning is performed by using laser light in the main scanning direction (light scanning method) so as to expose a photoconductor to light. These days, in order to meet a demand for reducing the size of a recording apparatus, a recording apparatus using a light-emitting-diode (LED) print head (LPH) in which plural LEDs used as light emitting elements are disposed in the main scanning direction to form a light-emitting-element array is coming into use.

In a light-emitting-element array including plural light emitting elements disposed linearly on a substrate, if a wiring pattern (line) for supplying a current to turn on light emitting elements is provided along the light-emitting-element array, the distance from the current supply point (terminal) provided at one end of the wiring pattern to one light emitting element is different from that to another light emitting element, thereby making the resistances (values) of the wiring pattern at the individual light emitting elements different. This causes a difference in the current flowing in the light emitting elements, thereby making the amounts of light emitted from the light emitting elements different. This may lead to a deterioration in the image quality.

It is thus desirable to suppress a difference in the quality of light emitted from light emitting elements used for image formation.

Exemplary embodiments of the invention will be described below in detail with reference to the accompanying drawings.

### First Exemplary Embodiment

### Image Forming Apparatus 1

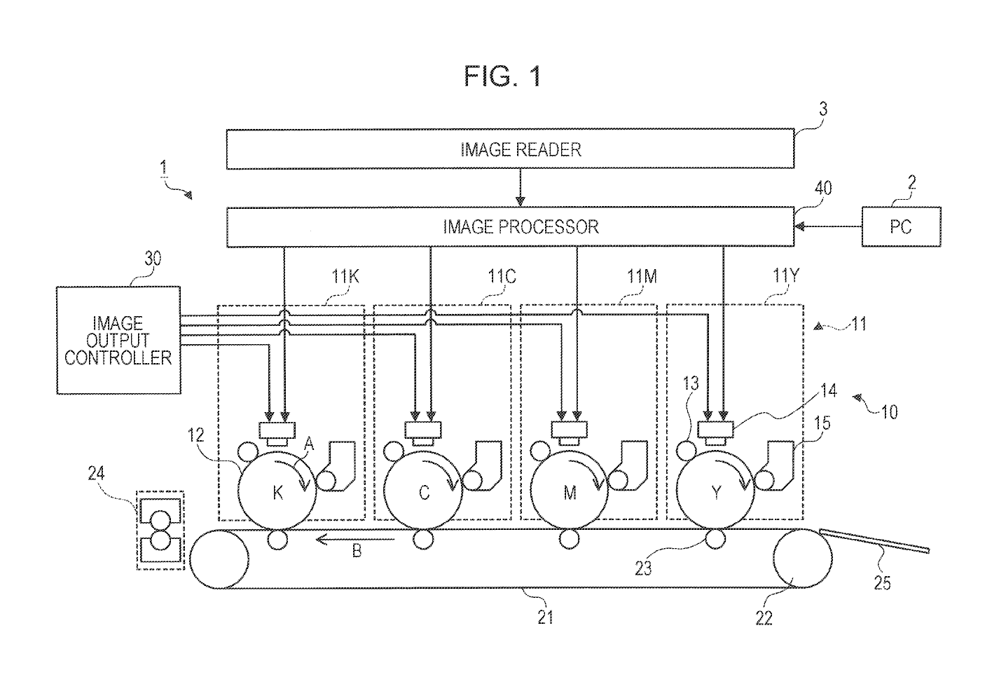

FIG. 1 illustrates an example of the overall configuration of an image forming apparatus 1 according to a first exemplary embodiment of the invention. The image forming apparatus 1 shown in FIG. 1 is a so-called tandem image forming apparatus. The image forming apparatus 1 includes an image forming processor 10, an image output controller 30, and an image processor 40. The image forming processor 10 forms images in accordance with image data elements of individual colors. The image output controller 30 controls the image forming processor 10. The image processor 40 is connected to, for example, a personal computer (PC) or an image reader 3, to perform predetermined image processing on image data received from the PC 2 or the image reader 3.

The image forming processor 10 includes an image forming unit 11 having plural engines that are disposed in parallel at predetermined intervals. The image forming unit 11 includes four image forming units 11Y, 11M, 11C, and 11K. The image forming units 11Y, 11M, 11C, and 11K each include a photoconductor drum 12, a charger 13, a print head 14, and a developing device 15. The photoconductor drum 12, which is an example of an image carrier, forms an electrostatic latent image thereon and carries a toner image thereon. The charger 13, which is an example of a charging device, charges the surface of the photoconductor drum 12 with a predetermined potential. The print head 14 exposes the photoconductor drum 12 charged by the charger 13 to light. The developing device 15, which is an example of a developing unit, develops an electrostatic latent image obtained by the print head 14. The image forming units 11Y, 11M, 11C, and 11K respectively form yellow (Y), magenta (M), cyan (C), and black (K) toner images.

The image forming processor 10 includes a sheet transfer belt 21 that transfers recording paper 25, which is an example of a transfer medium, drive rollers 22 that drive the sheet transfer belt 21, transfer rollers 23, which are an example of a transfer unit, that transfer toner images formed on the photoconductor drum 12 onto the recording paper 25, and a fixing device 24 that fixes toner images on the recording paper 25. By use of those elements, multilayer transfer of toner images onto the recording paper 25 is performed. More specifically, toner images of the individual colors formed on the photoconductor drum 12 of the image forming units 11Y, 11M, 11C, and 11K are transferred onto the recording paper 25 such that the toner images are superposed on one another.

In the image forming apparatus 1, the image forming processor 10 performs an image forming operation on the basis of various control signals supplied from the image output controller 30. Then, under the control of the image output controller 30, the image processor 40 performs image processing on image data received from the PC 2 or the image reader 3 and supplies the processed image data to the image forming unit 11. Then, for example, in the image forming unit 11K, the photoconductor drum 12 is charged to a predetermined potential by using the charger 13 while rotating in the direction indicated by arrow A in FIG. 1, and is exposed to light by using the print head 14. The print head 14 emits light on the basis of the image data supplied from the image processor 40. Accordingly, an electrostatic latent image corresponding to a K color image is formed on the photoconductor drum 12. Then, the electrostatic latent image formed on the photoconductor drum 12 is developed by the developing device 15 so that a K toner image is formed on the photoconductor drum 12. In the image forming units 11Y, 11M, and 11C, toner images of the Y, M, and C colors, respectively, are formed on the photoconductor drums 12.

The recording paper 25 is supplied in accordance with the movement of the sheet transfer belt 21 in the direction indicated by arrow B in FIG. 1. Then, the toner images of the individual colors formed on the photoconductor drums 12 of the image forming units 11Y, 11M, 11C, and 11K are sequentially transferred onto the recording paper 25 by using a transfer electric field applied to the transfer rollers 23. As a result, the toner images of the individual colors are superposed to form a synthesized toner image on the recording paper 25.

Subsequently, the recording paper 25 on which the synthesized toner image has been transferred is transported to the fixing device 24. The synthesized toner image is then subjected to fixing processing using heat and pressure by the fixing device 24 so as to be fixed on the recording paper 25. The resulting recording paper 25 is then discharged from the image forming apparatus 1.

### Print Head 14

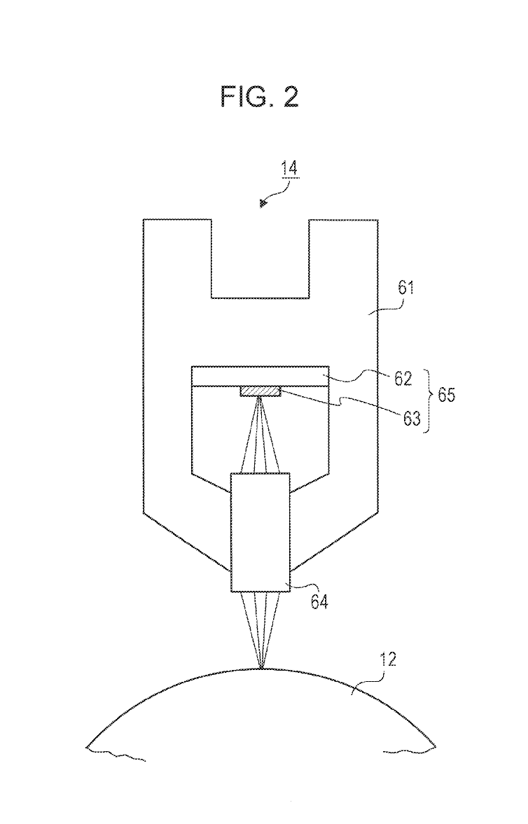

FIG. 2 is a sectional view illustrating the configuration of the print head 14. The print head 14, which is an example of an exposure device, includes a housing 61, a light emitting device 65, and a rod lens array 64. The light emitting device 65, which is an example of a light emitting unit, includes a light source 63 having plural light emitting elements (in this exemplary embodiment, light emitting thyristors) that expose the photoconductor drum 12 to light. The rod lens array 64, which is an example of an optical unit, causes light emitted from the light source 63 to form an image on the surface of the photoconductor drum 12.

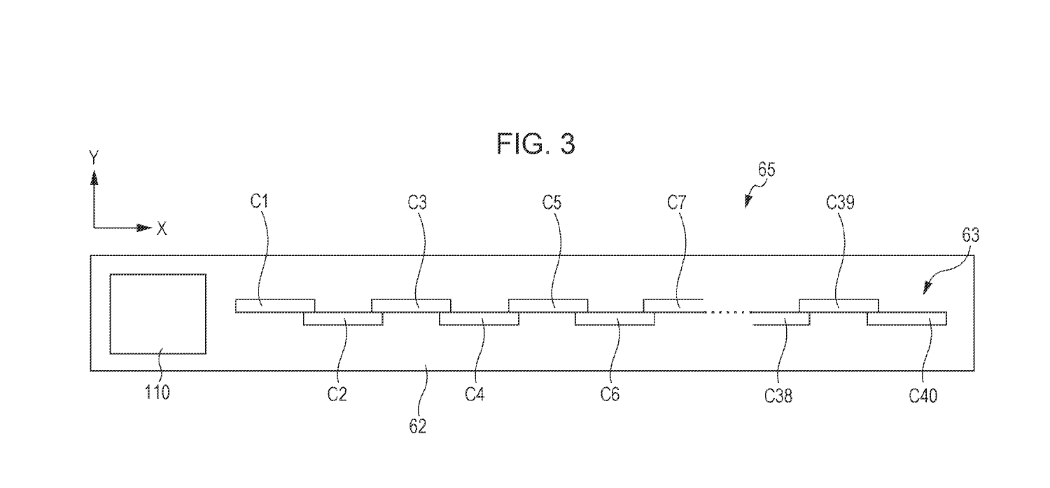

The light emitting device 65 includes the above-described light source 63 and a circuit board 62 on which a signal generating circuit 110 (see FIG. 3) for driving the light source 63 is mounted.

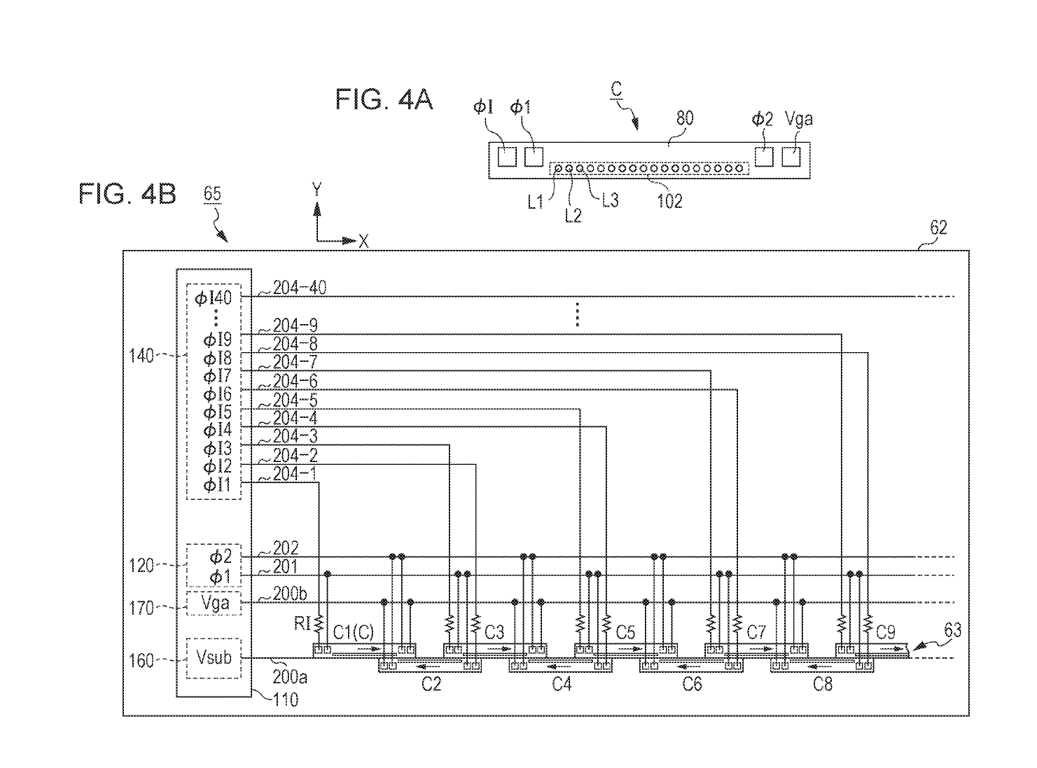

The housing 61 is made of, for example, metal. The housing 61 supports the circuit board 62 and the rod array lens 64 and is set such that the light emitting surfaces of the light emitting elements serve as the focal plane of the rod lens array 64. The rod lens array 64 is aligned along the axial direction (main scanning direction, i.e., X direction in FIGS. 3 and 4B) of the photoconductor drum 12.

### Light Emitting Device 65

FIG. 3 is a top view illustrating the light emitting device 65.

In the light emitting device 65 shown in FIG. 3 by way of example, the light source 63 is configured such that forty light emitting chips C1 through C40, which are an example of light emitting components, are disposed on the circuit board 62 in the X direction, which is the main scanning direction, in two lines in a zigzag manner.

The configurations of the light emitting chips C1 through C40 may be the same. Accordingly, when the light emitting chips C1 through C40 are not distinguished from one another, they are simply referred to as the “light emitting chip C”.

Although, in this exemplary embodiment, forty light emitting chips C are used, the number of light emitting chips C is not restricted to forty.

In the light emitting device 65, the signal generating circuit 110 for driving the light source 63 is mounted on the circuit board 62. The signal generating circuit 110 is constituted of, for example, an integrated circuit (IC). Although the signal generating circuit 110 is disposed in the light emitting device 65 in this exemplary embodiment, it may be disposed outside the light emitting device 65, in which case, control signals for controlling the light emitting chips C1 through C40 are supplied from the signal generating circuit 110 via a cable. It is assumed that, in this exemplary embodiment, the light emitting device 65 contains the signal processing circuit 110.

Details of the arrangement of the light emitting chips C1 through C40 will be given later.

FIG. 4A illustrates the configuration of the light emitting chip C. FIG. 4B illustrates the configuration of the signal generating circuit 110 of the light emitting device 65 and the configuration of the wiring patterns (lines) on the circuit board 62 of the light emitting device 65.

A description will first be given of the configuration of the light emitting chip C shown in FIG. 4A.

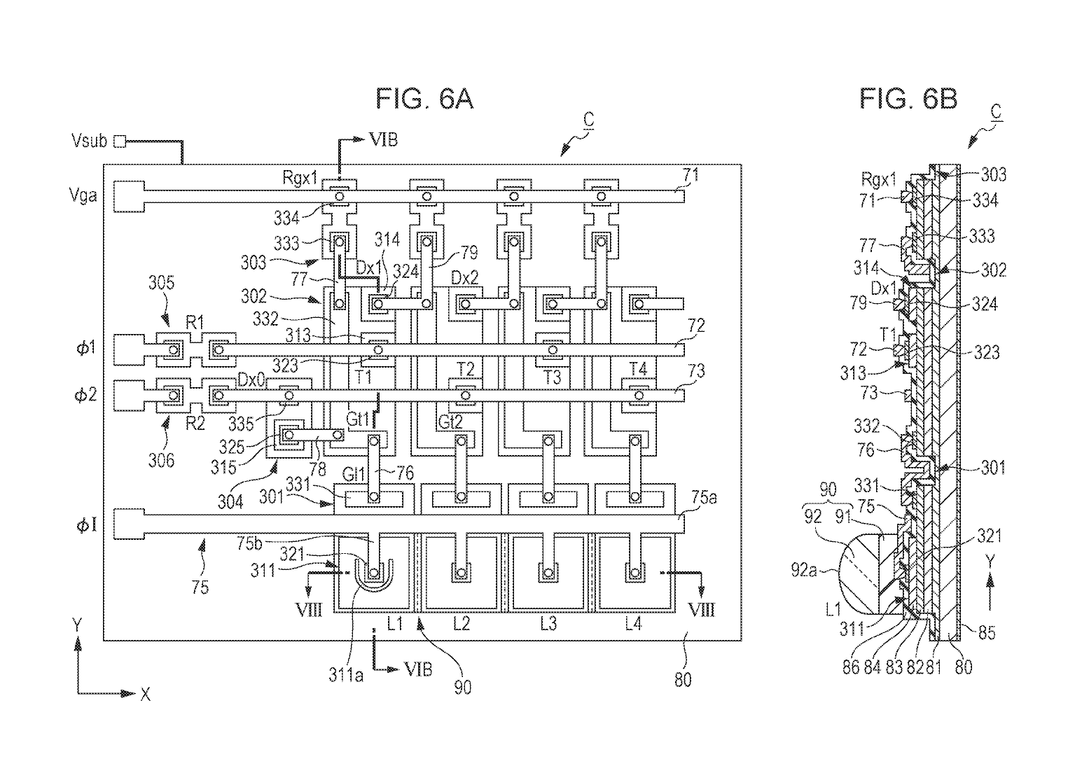

The light emitting chip C includes a light emitting section 102 on the surface of a substrate 80 which is formed in a rectangular shape as viewed above. The light emitting section 102 is constituted of plural light emitting elements (light emitting thyristors L1, L2, L3, etc. in this exemplary embodiment) which are substantially linearly disposed along and near one long side of the substrate 80. The light emitting chip C also includes plural terminals (φ1 terminal, φ2 terminal, Vga terminal, and φI terminal), which are bonding pads, for receiving various control signals, at both ends of the long sides on the surface of the substrate 80. Concerning the arrangement of those terminals, the φI and φ1 terminals are disposed in this order from one end of the substrate 80, while the Vga and φ2 terminals are disposed in this order from the other end of the substrate 80. The light emitting section 102 is disposed between the φ1 and φ2 terminals. On the back side of the substrate 80, a backside electrode 85 (see FIG. 6B), which serves as the Vsub terminal, is also disposed on the back side of the substrate 80.

In this specification, “light emitting elements are substantially linearly disposed” is not limited to only meaning that plural light emitting elements are disposed linearly (on a straight line), as shown in FIG. 4A, but may also mean that plural light emitting elements are displaced from each other with different amounts of displacement with respect to a direction orthogonal to the arrangement direction. For example, if light emitting surfaces 311 (see FIG. 6A) of light emitting elements are considered as pixels, the light emitting elements may be displaced from each other with amounts of displacement from several pixels to several tens of pixels with respect to the direction orthogonal to the arrangement direction. The light emitting elements may also be disposed in a zigzag manner such that every other (alternately) element is displaced in the direction orthogonal to the arrangement direction or such that every several elements are displaced in the direction orthogonal to the arrangement direction.

A description will now be given, with reference to FIG. 4B, of the configuration of the signal generating circuit 110 and the configuration of the wiring patterns (lines) on the circuit board 62.

As stated above, the signal generating circuit 110 and the light emitting chips C1 through C40 are mounted on the circuit board 62 of the light emitting device 65. Wiring patterns (lines) for connecting the signal generating circuit 110 and the light emitting chips C1 through C40 are also provided.

The configuration of the signal processing circuit 110 will first be described.

Image data subjected to image processing by the image output controller 30 and the image processor 40 (see FIG. 1) and various control signals are input into the signal generating circuit 110. The signal generating circuit 110 rearranges image data, corrects the amounts of light, etc. on the basis of the image data and the various control signals.

The signal generating circuit 110 includes a transfer signal generator 120 that transmits a first transfer signal φ1 and a second transfer signal φ2 to the light emitting chips C1 through C40 on the basis of various control signals.

The signal generating circuit 110 also includes a lighting signal generator 140 that transmits lighting signals φI1 through φI40 to the light emitting chips C1 through C40, respectively, on the basis of various control signals. When the lighting signals φI1 through φI40 are not distinguished from one another, they are simply referred to as the “lighting signal φI”.

The signal generating circuit 110 also includes a reference potential supply section 160 that supplies the reference potential Vsub, which is the reference of the potential, to the light emitting chips C1 through C40, and includes a power supply potential supply section 170 that supplies the power supply potential Vga for driving the light emitting chips C1 through C40.

The arrangement of the light emitting chips C1 through C40 will be discussed below.

The odd-numbered light emitting chips C1, C3, C5, etc. are aligned longitudinally on the substrate 80 with a spacing therebetween. Similarly, even-numbered light emitting chips C2, C4, C6, etc. are aligned longitudinally on the substrate 80 with a spacing therebetween. The odd-numbered light emitting chips C1, C3, C5, etc. and the even-numbered light emitting chips C2, C4, C6, etc. are disposed alternately in a zigzag manner such that they are displaced from each other by 180°. With this arrangement, the long side of an odd-numbered light emitting chip C on which the light emitting section 102 is disposed faces that of an even-numbered light emitting chip C on which the light emitting section 102 is disposed. From the viewpoint of the entire light emitting chips C, the light emitting chips C are positioned in the main scanning direction (X direction) with a predetermined spacing therebetween. The directions of the arrangement of the light emitting elements (in the order of light emitting thyristors L1, L2, L3, etc., in this exemplary embodiment) of the light emitting section 102 shown in FIG. 4A are indicated by the arrows in the light emitting chips C1, C2, C3, etc., shown in FIG. 4B.

The wiring patterns (lines) for connecting the signal generating circuit 110 and the light emitting chips C1 through C40 will be discussed below.

On the circuit board 62, a power supply line 200a is provided. The power supply line 200a is connected to the Vsub terminals provided on the back side of the substrate 80 as the backside electrodes 85 (see FIG. 6B) so as to supply the reference potential Vsub to the Vsub terminals.

On the circuit board 62, a power supply line 200b is also provided. The power supply line 200b is connected to the Vga terminals provided for the light emitting chips C so as to supply the power supply potential Vga to the Vga terminals.

On the circuit board 62, a first transfer signal line 201 and a second transfer signal line 202 are provided. The transfer signal generator 120 of the signal generating circuit 110 transmits a first transfer signal φ1 to the φ1 terminals of the light emitting chips C1 through C40 through the first transfer signal line 201, and transmits a second transfer signal φ2 to the φ2 terminals of the light emitting chips C1 through C40 through the second transfer signal line 202. The first and second transfer signals φ1 and φ2 are transmitted in parallel to all the light emitting chips C1 through C40.

On the circuit board 62, lighting signal lines 204-1 through 204-40 are provided. Through the lighting signal lines 204-1 through 204-40, the lighting signal generator 140 of the signal generating circuit 110 transmits lighting signals φI1 through φI40, respectively, to the φI terminals of the light emitting chips C1 through C40 via the corresponding current regulating resistors RI.

As described above, the reference potential Vsub and the power supply potential Vga are supplied to all the light emitting chips C1 through C40 on the circuit board 62. The first and second transfer signals φ1 and φ2 are also transmitted (in parallel) to all the light emitting chips C1 through C40. In contrast, the lighting signals φI1 through φI40 are individually supplied to the light emitting chips C1 through C40, respectively.

If the light emitting device 65 does not include the signal generating circuit 110, the power supply lines 200a and 200b, the first and second transfer lines 201 and 202, and the lighting signal lines 204-1 through 204-40 are connected to a connector instead of the signal generating circuit 110. Then, the light emitting device 65 is connected to the signal generating circuit 110 which is externally disposed by using this connector via a cable.

### Light Emitting Chip C

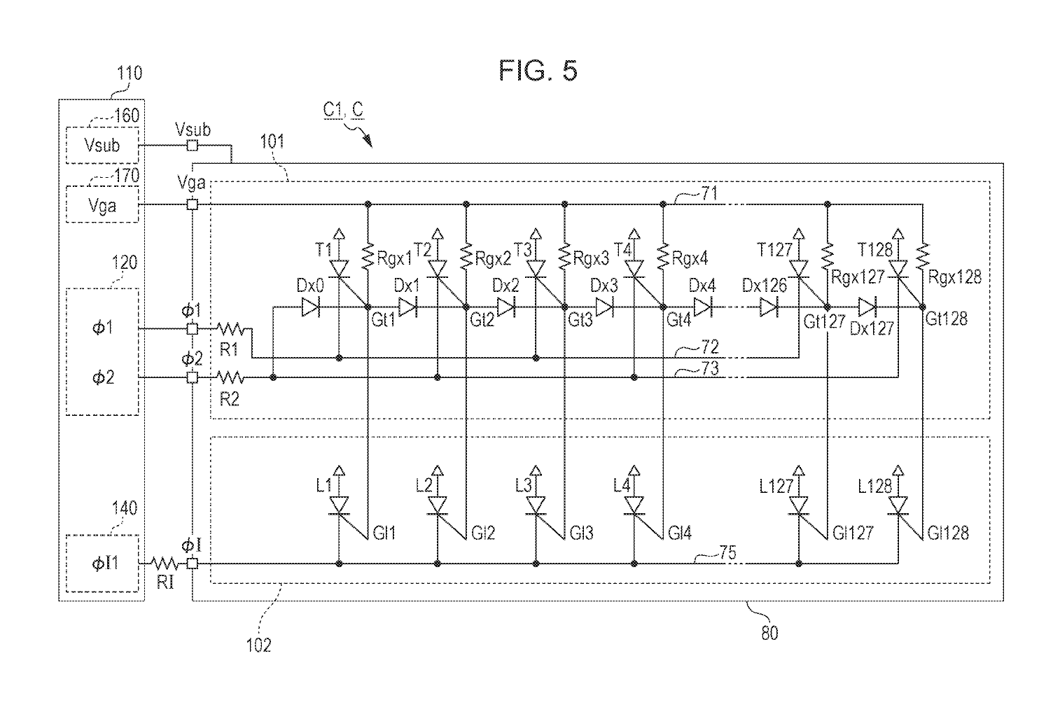

FIG. 5 is an equivalent circuit diagram illustrating the circuit configuration of the light emitting chip C of this exemplary embodiment on which a single self-scanning light emitting device array (SLED) is mounted. The light emitting elements, which will be discussed below, are arranged on the basis of the layout (see FIG. 6A) on the light emitting chip C, except for the terminals (φ1 terminal, φ2 terminal, Vga terminal, and φI terminal). The positions of the terminals (φ1 terminal, φ2 terminal, Vga terminal, and φI terminal) shown in FIG. 6A are different from those shown in FIG. 4A, and the terminals are shown at the left side in FIG. 5 to describe the connecting relationship of the terminals to the signal generating circuit 110. The Vsub terminal provided on the back side of the substrate 80 is extended to the outside the substrate 80.

To describe the relationship of the terminals to the signal generating circuit 110, the light emitting chip C will be described by taking the light emitting chip C1 as an example. Accordingly, in FIG. 5, the light emitting chip C is shown as light emitting chip C(C1). The configurations of the other light emitting chips C2 through C40 are the same as the configuration of the light emitting chip C1.

The light emitting chip C1 includes a light emitting thyristor array (light emitting section 102 (see FIG. 4A)) having light emitting thyristors L1, L2, L3, etc. which are linearly arranged on the substrate 80.

The light emitting chip C1 also includes a transfer thyristor array having transfer thyristors T1, T2, T3, etc. which are also linearly arranged, similarly to the light emitting thyristor array.

Adjacent thyristors, e.g., T1 and T2, T3 and T4, etc., which are next to each other, are formed into pairs, and corresponding coupling diodes Dx1, Dx2, Dx3, etc. are each provided between the two adjacent thyristors of a pair.

The light emitting chip C1(C) also includes power supply line resistors Rgx1, Rgx2, Rgx3, etc.

The light emitting chip C1(C) also includes one start diode Dx0. Then, current regulating resistors R1 and R2 are respectively provided for preventing an excessive current from flowing in first and second transfer signal lines 72 and 73 through which the first and second transfer signals φ1 and φ2 are transmitted. The first and second transfer signal lines 72 and 73 will be discussed below.

The light emitting thyristors L1, L2, L3, etc. of the light emitting thyristor array, the transfer thyristors T1, T2, T3, etc. of the transfer thyristor array are arranged from the left side of FIG. 5 in numerical order. The coupling diodes Dx1, Dx2, Dx3, etc. and the power supply line resistors Rgx1, Rgx2, Rgx3, etc. are also arranged from the left side of FIG. 5 in numerical order.

The transfer thyristor array and the light emitting thyristor array are arranged in this order from the top of FIG. 5.

Concerning the light emitting thyristors L1, L2, L3, etc., the transfer thyristors T1, T2, T3, etc., the coupling diodes Dx1, Dx2, Dx3, etc., and the power supply line resistors Rgx1, Rgx2, Rgx3, etc., when the same components are not individually distinguished from one another, they are simply referred to as the “light emitting thyristor L” “transfer thyristor T”, “coupling diode Dx”, and “power supply line resistor Rgx”, respectively.

In this exemplary embodiment, the number of light emitting thyristors L of the light emitting thyristor array, the number of transfer thyristors T of the transfer thyristor array, and the number of power supply line resistors Rgx are each 128. That is, 128 light emitting thyristors L1 through L128, 128 transfer thyristors T1 through T128, and 128 power supply line resistors Rg1 through Rg128 are provided. However, the number of coupling diodes Dx is 127, which is smaller than the number of transfer thyristors T by one. That is, 127 coupling diodes Dx1 through Dx127 are provided.

The number of light emitting thyristors T is not restricted to 128, and may be a predetermined number.

The number of transfer thyristors T may be greater than that of light emitting thyristors L.

The above-described thyristors (light emitting thyristors L or transfer thyristors T) are semiconductor devices each including three terminals, i.e., a gate terminal, an anode terminal, and a cathode terminal.

The electrical connection among the elements of the light emitting chip C1(C) will be discussed below.

The anode terminals of the transfer thyristor T and the light emitting thyristor L are connected to the substrate 80 of the light emitting chip C1(C) (common anode).

The anode terminals are connected to the power supply line 200a (see FIG. 4B) via the backside electrodes 85 (see FIG. 6B), which are the Vsub terminals, provided on the back side of the substrates 80. Through the power supply line 200a, the reference potential Vsub is supplied from the reference potential supply section 160.

Along the arrangement of the transfer thyristors T, the cathode terminals of the odd-numbered transfer thyristors T1, T3, etc. are connected to the first transfer signal line 72. Then, the first transfer signal line 72 is connected to the φ1 terminal via the current regulating resistor R1. The first transfer signal line 201 (see FIG. 4B) is connected to the φ1 terminal, and the first transfer signal φ1 is transmitted from the transfer signal generator 120 via the first transfer signal line 201.

Meanwhile, along the arrangement of the transfer thyristors T, the cathode terminals of the even-numbered transfer thyristors T2, T4, etc. are connected to the second transfer signal line 73. Then, the second transfer signal line 73 is connected to the φ2 terminal via the current regulating resistor R2. The second transfer signal line 202 (see FIG. 4B) is connected to the φ2 terminal, and the second transfer signal φ2 is transmitted from the transfer signal generator 120 via the second transfer signal line 202.

The cathode terminals of the light emitting thyristors L1, L2, L3, etc. are connected to a lighting signal line 75. The lighting signal line 75 is connected to the φI terminal. In the light emitting chip C1, the φI terminal is connected to the lighting signal line 204-1 via the current regulating resistor RI so that the lighting signal φI1 is transmitted from the lighting signal generator 140. The lighting signal φI1 is transmitted to supply a current for turning ON the light emitting thyristors L1 through L128. The lighting signal lines 204-2 through 204-40 are respectively connected to the φI terminals of the light emitting chips C2 through C40 via the corresponding current regulating resistors RI. Through the lighting signal lines 204-2 through 204-40, the lighting signals φI2 through φI40 are respectively transmitted from the lighting signal generator 140 to the light emitting chips C2 through C40.

That is, the φI terminal is an example of the power feeding point, and the lighting signal line 75 is an example of a wiring pattern through which a current for turning ON the light emitting thyristors L1, L2, L3, etc. (causing the light emitting thyristors L1, L2, L3, etc. to emit light) is supplied.

The gate terminals Gt1, Gt2, Gt3, etc., of the transfer thyristors T1, T2, T3, etc., respectively, are connected to the gate terminals Gl1, Gl2, Gl3, etc. of the light emitting thyristors L1, L2, L3, etc., respectively, based on a one-on-one correspondence. Accordingly, the gate terminals Gt1, Gt2, Gt3, etc. are electrically at the same potential as the gate terminals Gl1, Gl2, Gl3, etc, respectively. Thus, when the gate terminals Gt1 and Gl1 are collectively expressed as “gate terminal Gt1 (gate terminal Gl1)”, they are at the same potential.

When the gate terminals Gt1, Gt2, Gt3, etc. and the gate terminals Gl1, Gl2, Gl3, etc., are not distinguished from one another, they are simply referred to as the “gate terminal Gt” and “gate terminal Gl”, respectively. When the gate terminals Gt and Gl are collectively expressed as the “gate terminal Gt (gate terminal Gl)”, they are at the same potential.

Adjacent gate terminals, e.g., Gt1 and Gt2, Gt3 and Gt4, etc., which are next to each other, of the transfer thyristors T1, T2, T3, etc. are formed into pairs, and the corresponding coupling diodes Dx1, Dx2, Dx3, etc. are each provided between the two adjacent gate terminals of a pair. That is, the coupling diodes Dx1, Dx2, Dx3, etc. are connected in series with the gate terminals Gt1, Gt2, Gt3, etc. such that they are each inserted between the corresponding pair of the gate terminals Gt1, Gt2, Gt3, etc. That is, the coupling diode Dx1 is connected between the gate terminals Gt1 and Gt2 in the direction in which a current flows from the gate terminal Gt1 to the gate terminal Gt2. The same applies to the other coupling diodes Dx2, Dx3, Dx4, etc.

The gate terminal Gt (gate terminal Gl) of the transfer thyristor T is connected to a power supply line 71 via the power supply line resistor Rgx provided for the corresponding transfer thyristor T. The power supply line 71 is connected to the Vga terminal. The power supply line 200b (see FIG. 4B) is connected to the Vga terminal, and the power supply potential Vga is supplied from the power supply potential supply section 170 to the light emitting chips C1 through C40 through the power supply line 200b.

The gate terminal Gt1 of the transfer thyristor T1 at one end of the transfer thyristor array is connected to the cathode terminal of the start diode Dx0. The anode terminal of the start diode Dx0 is connected to the second transfer signal line 73.

In FIG. 5, the portion including the transfer thyristor T, the coupling diode Dx, the power supply line resistor Rgx, the start diode Dx0, and the current regulating resistors R1 and R2 corresponds to a transfer section 101. The portion including the light emitting thyristor L corresponds to the light emitting section 102.

FIGS. 6A and 6B are respectively a plan view illustrating the layout of the light emitting chip C according to the first exemplary embodiment and a sectional view taken along line VIB-VIB of FIG. 6A. Since the connection relationship between the light emitting chip C and the signal generating circuit 110 is not shown in FIG. 6A or 6B, it is not necessary to take a specific emitting chip, e.g., C1, as an example. Accordingly, the light emitting chip is simply designated “light emitting chip C”.

FIG. 6A illustrates the light emitting thyristors L1 through L4, the transfer thyristors T1 through T4, and surrounding portions thereof. The positions of the terminals (φ1 terminal, φ2 terminal, Vga terminal, and φI terminal) shown in FIG. 6A are different from those shown in FIG. 4A, and the terminals are shown at the left side in FIG. 6A for the sake of description. The Vsub terminal provided on the back side of the substrate 80 extends to the outside of the substrate 80. If the terminals are provided in accordance with those shown in FIG. 4A, the φ2 terminal, the Vga terminal, and the current regulating resistor R2 are provided at the right side of the substrate 80 in FIG. 6A. The start diode Dx0 may be provided at the right side of the substrate 80.

FIG. 6B is a sectional view taken along line VIB-VIB of FIG. 6A. In FIG. 6B, the cross sections of the light emitting thyristor L1, the transfer thyristor T1, the coupling diode Dx1, and the power supply line resistor Rgx1 are shown from the bottom of FIG. 6B. In FIGS. 6A and 6B, the major elements and terminals are designated by the corresponding signs.

The light emitting chip C includes, as shown in FIG. 6B, plural islands (first, second, and third islands 301, 302, and 303, which will be discussed below) formed by sequentially stacking a p-type first semiconductor layer 81, an n-type second semiconductor layer 82, a p-type third semiconductor layer 83, and an n-type fourth semiconductor layer 84 on the p-type substrate 80. That is, by forming the plural islands, at least the n-type second semiconductor layer 82, the p-type third semiconductor layer 83, and the n-type fourth semiconductor layer 84 are divided into separate portions. The p-type first semiconductor layer 81 may be divided or not divided into separate portions. In FIG. 6B, the p-type first semiconductor layer 81 is divided only partway through in the thickness direction. The p-type first semiconductor layer 81 may also serve as the substrate 80.

Moreover, as will be discussed later, among the plural islands, some islands include part of the n-type fourth semiconductor layer 84 (e.g., the first island 301), and some islands do not include the n-type fourth semiconductor layer 84 (e.g., the third island 303).

In the light emitting chip C, as shown in FIG. 6B, an insulating layer 86 is provided such that it covers the top and side surfaces of those islands. Then, the islands are connected to the wiring patterns, such as the power supply line 71, the first transfer signal line 72, the second transfer signal line 73, and the lighting signal line 75 via through-holes (indicated by circles in FIG. 6A). A description of the insulating layer 86 and the through-holes will be omitted.

As shown in FIG. 6A, the light emitting thyristor L1 is provided on the first island 301. The light emitting thyristor L1 emits light mainly by using the n-type second semiconductor layer 82 and the p-type third semiconductor layer 83 (see FIG. 6B). In order to extract light from the n-type fourth semiconductor layer 84, which serves as the cathode, the surface of the n-type fourth semiconductor layer 84 of the light emitting thyristor L is used as the light emitting surface 11.

Then, as shown in FIG. 6B, a lens 90 is provided on the insulating layer 86, which covers an n-type ohmic electrode 321, and on the lighting signal line 75 (branch portion 75b) such that the lens 90 faces the light emitting surface 311 of the light emitting thyristor L1. The lighting signal line 75 is connected to the n-type ohmic electrode 321 via a through-hole provided in the insulating layer 86.

The lens 90 includes a base 91 and a lens portion 92.

The base 91 is provided to cover the step portions formed by the n-type ohmic electrode 321 disposed on the light emitting surface 311 of the light emitting thyristor L1 and by the lighting signal line 75 (branch portion 75b) connected to the n-type ohmic electrode 321 via the through-hole formed in the insulating layer 86, thereby flattening such step portions.

The lens portion 92 formed in a convex shape is provided on the base 91 on a side away from the light emitting surface 311. The lens portion 92 is provided such that it faces the light emitting surface 311, and serves as a convex lens having a light-focusing function. In contrast, the base 91 does not have a light-focusing function.

It is now assumed that the light emitting surface 311 has a square shape and that the n-type ohmic electrode 321 is provided at the central portion of the light emitting surface 311. The center of the lens portion 92 coincides with the center of the light emitting surface 311. The center of the lens portion 92 is at the position of a point obtained by vertically projecting a point (vertex 92a) which is positioned farthest from the light emitting surface 311 onto the light emitting surface 311. The center of the light emitting surface 311 is the center of gravity, assuming that the light emitting surface 311 is a board having a uniform density.

In the second island 302, the transfer thyristor T1 and the coupling diode Dx1 are disposed. In the third island 303, the power supply line resistor Rgx1 is provided. In a fourth island 304, the start diode Dx0 is provided. In a fifth island 305, the current regulating resistor R1 is provided. In a sixth island 306, the current regulating resistor R2 is provided.

On the light emitting chip C, plural islands similar to the first, second, and third islands 301, 302, and 303 are formed in parallel with each other. In those islands, the light emitting thyristors L2, L3, L4, etc., the transfer thyristors T2, T3, T4, etc., the coupling diodes Dx2, Dx3, Dx4, etc., and the power supply resistors Rgx2, Rgx3, Rgx4, etc. are provided similarly to those in the first, second, and third islands 301, 302, and 303. The lens 90 is provided on each of the light emitting thyristors L2, L3, L4, etc.

On the back side of the substrate 80, as shown in FIG. 6B, the backside electrode 85, which is the Vsub terminal, is disposed.

The plural lenses 90 provided for the light emitting thyristors L1, L2, L3, etc. form a lens array provided along the light emitting thyristor array.

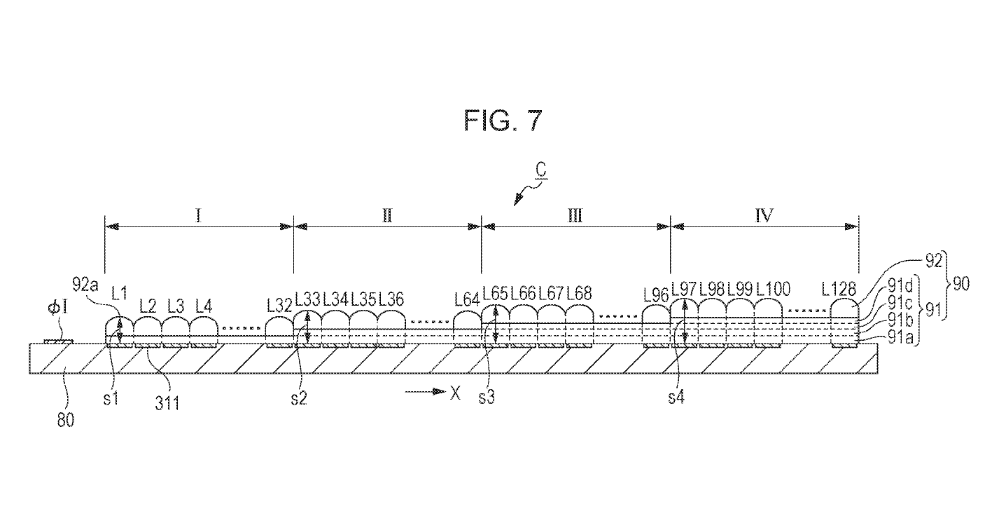

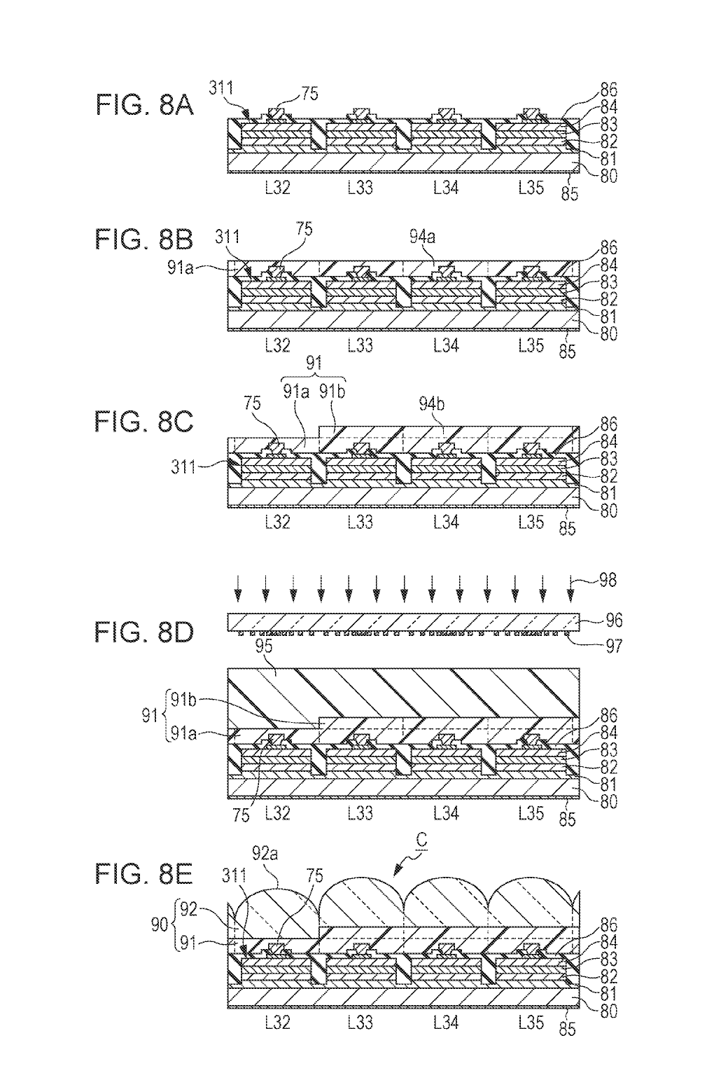

The lens array is configured such that the peripheral portions of the lenses 90 are in contact with each other in the direction in which the lens array is arranged (see FIGS. 7 and 8E). That is, it is possible that the convex surfaces of the lens portions 92 extend beyond the light emitting surface 311. However, the overlapping portions of the convex surfaces between the adjacent light emitting thyristors L are eliminated so that the peripheral portions of the lenses 90 are integrally formed in contact with each other.

The lens array is cut along a cross-sectional surface thereof at both ends of the lens array and in the direction orthogonal to the direction in which the lens array is arranged. This will be more specifically described. It is possible that the convex surfaces of the lens portions 92 of the lenses 90 extend beyond the area of the light emitting surface 311. However, such extended portions are cut off at both ends of the lens array and in the direction orthogonal to the direction in which the lens array is arranged. The amount that is cut of from the convex surfaces of the lens portions 92 may be set by considering the efficiency with which light emitted sideways from the light emitting surface 311 of the light emitting thyristor L is incident on the rod lens array 64.

Although the lenses 90 are integrally in contact with each other between the adjacent light emitting thyristors L, it is assumed that the lens 90 is provided for each light emitting thyristor L.

Details of the configuration of the lenses 90 will be given below.

The first through sixth islands 301 through 306 will be described below in detail with reference to FIGS. 6A and 6B.

In the light emitting thyristor L1 provided in the first island 301, the p-type first semiconductor layer 81 provided on the p-type substrate 80 is used as the anode terminal, the n-type ohmic electrode 321 provided on the n-type fourth semiconductor layer 84 is used as the cathode terminal, and a p-type ohmic electrode 331 provided on the p-type third semiconductor layer 83 which is exposed by removing the n-type fourth semiconductor layer 84 is used as the gate terminal Gl1. Then, light emits from the surface (light emitting surface 311) of the n-type fourth semiconductor layer 84 via the insulating layer 86 and the lens 90.

The emission of light is blocked on the light emitting surface 311 at the portion in which the n-type ohmic electrode 321 is provided and at the portion in which the branch portion 75b for connecting the lighting signal line 75 with the n-type ohmic electrode 321 is provided. Accordingly, on the light emitting surface 311, the portion from which light is actually emitted is a U-shaped portion (horseshoe region 311a (see FIG. 6B)) surrounding the branch portion 75b of the lighting signal line 75 and the n-type ohmic electrode 321.

In this description, the light emitting surface 311 is used not only for the light emitting thyristor L1, but also for the other light emitting thyristors L.

In the transfer thyristor T1 provided in the second island 302, the p-type first semiconductor layer 81 provided on the p-type substrate 80 is used as the anode terminal, an n-type ohmic electrode 323 provided in a region 313 of the n-type fourth semiconductor layer 84 is used as the cathode terminal, and a p-type ohmic electrode 332 provided on the p-type third semiconductor layer 83 which is exposed by removing the n-type fourth semiconductor layer 84 is used as the gate terminal Gt1.

In the coupling diode Dx1 also provided in the second island 302, an n-type ohmic electrode 324 provided in a region 314 of the n-type fourth semiconductor layer 84 is used as the cathode terminal, and the p-type ohmic electrode 332 provided on the p-type third semiconductor layer 83 is used as the anode terminal. The p-type ohmic electrode 332 is used both as the anode terminal of the coupling diode Dx1 and the gate terminal Gt1 of the transfer thyristor T1.

In the power supply line resistor Rgx1 provided in the third island 303, the p-type third semiconductor layer 83 between p-type ohmic electrodes 333 and 334 provided on the p-type third semiconductor layer 83 which is exposed by removing the n-type fourth semiconductor layer 84 is used as the resistor.

In the start diode Dx0 provided in the fourth island 304, an n-type ohmic electrode 325 provided on a region 315 of the n-type fourth semiconductor layer 84 is used as the cathode terminal, and a p-type ohmic electrode 335 provided on the p-type third semiconductor layer 83 which is exposed by removing the n-type fourth semiconductor layer 84 is used as the anode terminal.

In each of the current regulating resistors R1 and R2 provided in the fifth and sixth islands 305 and 306, respectively, the p-type third semiconductor layer 83 between two p-type ohmic electrodes (no reference numerals) is used as the resistor, as in the power supply line resistor Rgx1 provided in the third island 803.

The relationships among which the elements of the light emitting chip C in FIG. 6A are connected will be described below.

The lighting signal line 75 includes a trunk portion 75a and the plural branch portions 75b. The trunk portion 75a is provided to extend in the direction in which the light emitting thyristor array is arranged. The branch portions 75b branch off from the trunk portion 75a and are connected to the corresponding n-type ohmic electrodes 321, which serve as the cathode terminals of the light emitting thyristors L provided in the first island 301.

The lighting signal line 75 is connected from the φI terminal provided near the light emitting thyristor L1 of the light emitting thyristor array.

The path in the lighting signal line 75 through which the lighting signal φI flows becomes longer and farther from the φI terminal as the light emitting thyristor L number becomes greater. That is, as the light emitting thyristor L number becomes greater, the resistance (value) of the path in the lighting signal line 75 through which the lighting signal φI flows increases. Accordingly, if the lighting signal φI is transmitted at a constant voltage, the current flowing in the light emitting thyristor L decreases as the light emitting thyristor L number increases, which causes a difference in the amount of light emitted from the light emitting thyristors L. The current of the lighting signal φI transmitted for turning ON the light emitting thyristor L is larger than the currents of the first and second transfer signals φ1 and φ2 transmitted to the transfer thyristor T. Thus, the lighting signal φI is more likely to be influenced by the resistance (value) of the path in the lighting signal line 75.

The first transfer signal line 72 is connected to the n-type ohmic electrode 323, which serves as the cathode terminal of the transfer thyristor T1, provided in the second island 302. The first transfer signal line 72 is also connected to the cathode terminals of the other odd-numbered transfer thyristors T provided in islands similar to the second island 302. The first transfer signal line 72 is connected to the φ1 terminal via the current regulating resistor R1 provided in the fifth island 305.

Meanwhile, the second transfer signal line 73 is connected to n-type ohmic electrodes (no reference numerals), which serve as the cathode terminals of the even-numbered transfer thyristors T, provided in islands (no reference numerals).

The second transfer signal line 73 is connected to the φ2 terminal via the current regulating resistor R2 provided in the sixth island 306.

The power supply line 71 is connected to the p-type ohmic electrode 334, which also serves as one terminal of the power supply line resistor Rgx1, provided in the third island 303. The power supply line 71 is also connected to the p-type ohmic electrodes 334, each of which also serves as one terminal of the corresponding power supply line resistor Rgx. The power supply line 71 is connected to the Vga terminal.

The p-type ohmic electrode 331 (gate terminal Gl1) of the light emitting thyristor L1 provided in the first island 301 is connected to the p-type ohmic electrode 332 (gate terminal Gt1) provided in the second island 302 via a connecting wiring 76.

The p-type ohmic electrode 332 (gate terminal Gt1) is connected to the p-type ohmic electrode 333 (the other terminal of the power supply line resistor Rgx1) provided in the third island 303 via a connecting wiring 77.

The n-type ohmic electrode 324 (cathode terminal of the coupling diode Dx1) provided in the second island 302 is connected to a p-type ohmic electrode (no reference numeral), which is the gate terminal Gt2 of the adjacent transfer thyristor T2, via a connecting wiring 79.

The same applies to the other light emitting thyristors L, transfer thyristors T, and coupling diodes Dx, though a description is not given.

The p-type ohmic electrode 332 (gate terminal Gt1) provided in the second island 302 is connected to the n-type ohmic electrode 325 (cathode terminal of the start diode Dx0) provided in the fourth island 304 via a connecting wiring 78. The p-type ohmic electrode 335 (anode terminal of the start diode Dx0) is connected to the second transfer signal line 73.

FIG. 7 illustrates the lenses 90 (including the bases 91 and the lens portions 92) provided on the light emitting thyristor L according to the first exemplary embodiment. In FIG. 7, the n-type ohmic electrode 321, the lighting signal line 75 (branch portion 75b), the insulating layer 86, and the through-holes on the light emitting surface 311 are not shown, and only the lenses 90 provided on the light emitting surfaces 311 are shown.

In the first exemplary embodiment, among the 128 light emitting thyristors, concerning the light emitting thyristors L1 through L32 belonging to a light emitting thyristor group I, the distance from the light emitting surface 311 to the vertex 92a of the lens 90 is set to be a height s1. Concerning the light emitting thyristors L33 through L64 belonging to a light emitting thyristor group II, the distance from the light emitting surface 311 to the vertex 92a of the lens 90 is set to be a height s2. Concerning the light emitting thyristors L65 through L96 belonging to a light emitting thyristor group III, the distance from the light emitting surface 311 to the vertex 92a of the lens 90 is set to be a height s3. Concerning the light emitting thyristors L97 through L128 belonging to a light emitting thyristor group IV, the distance from the light emitting surface 311 to the vertex 92a of the lens 90 is set to be a height s4. The height s1 is the smallest, and the heights s2, s3, and s4 become larger in ascending order (s1<s2<s3<s4). If the heights s1, s2, s3, and s4 are not distinguished from one another, they are simply referred to as the “height s”. That is, the height s becomes smaller as the light emitting thyristor L is closer to the φI terminal. In other words, the height s becomes larger as the light emitting thyristor L is farther from the φI terminal.

The light emitting thyristor groups I, II, III, IV are examples of light emitting element groups.

FIG. 7 shows that the base 91 is divided into four portions (91a, 91b, 91c, and 91d) to provide the difference in the height s (see FIGS. 8B through 8D). For the height s1, only the base 91a is provided. For the height s2, the bases 91a and 91b are stacked. For the height s3, the bases 91a, 91b, and 91c are stacked. For the height s4, the bases 91a, 91b, 91c, and 91d are stacked.

That is, the difference in the height s is provided by changing the thickness of the base 91 (height from the light emitting thyristor L to the boundary between the base 91 and the lens portion 92). The configurations of the lens portions 92 are the same.

The lens 90 is divided into the base 91 and the lens portion 92 for the sake of convenience only, and the portions of the lenses 90 for all the light emitting thyristors L are used as the lens portions 92, and the portions different among the light emitting thyristors L are used as the base 91. The base portion 91a may be integrated into the lens portion 92. In this case, in the light emitting thyristor group I, no base 91 is provided, i.e., the thickness of the base 91 is 0.

The light emitting chip C1(C) shown in FIG. 5 is formed as described above.

### Manufacturing Method for Light Emitting Chip C

A manufacturing method for the light emitting chip C will be described below.

A description will first be given of a manufacturing method for the light emitting chip C before mounting the lenses 9.

A compound semiconductor, such as GaAs or GaAlAs, is used. On the p-type substrate 80, the p-type first semiconductor layer 81, the n-type second semiconductor layer 82, the p-type third semiconductor layer 83, the n-type fourth semiconductor layer 84 are sequentially stacked, and then, the n-type fourth semiconductor layer 84, the p-type third semiconductor layer 83, the n-type second semiconductor layer 82, and a predetermined depth of the p-type first semiconductor layer 81 from the interface with the n-type second semiconductor layer 82 are removed by etching, thereby forming plural islands (first through six islands 301 through 306 and other islands) separated from each other. The islands are called “mesa”, and etching for forming islands is called “mesa etching”.

In some islands, by partially removing the n-type fourth semiconductor layer 84, and in some islands, by entirely removing the n-type fourth semiconductor layer 84, the p-type third semiconductor layer 83 is exposed.

Then, on the surface of the n-type fourth semiconductor layer 84, the n-type ohmic electrodes 321, 323, 324, 325, etc. are formed. On the surface of the exposed p-type third semiconductor layer 83, the p-type ohmic electrodes 331, 332, 333, 334, 335, etc. are formed.

Then, the insulating layer 86 made of, for example, silicon dioxide (SiO₂), is formed to cover the top surface and the side surface of the islands. Then, through-holes are provided on the insulating layer 86 on which the n-type ohmic electrodes and the p-type ohmic electrodes are formed. A metal film, such as aluminum (Al), is deposited, and is processed into the power supply line 71, the first transfer signal line 72, the second transfer signal line 73, and the lighting signal line 75 by using photolithography.

With this manufacturing method, the light emitting chip C before mounting the lenses 90 is manufactured.

The method for forming the lenses 90 of the light emitting chip C will be discussed below. In this exemplary embodiment, the lenses 90 are formed by using photoconductive materials 94a, 94b, and 95 (see FIGS. 8B through 8D). More specifically, patterns are formed from the photoconductive materials 94a, 94b, and 95 by using photolithography, and are then cured. The cured patterns are used as the bases 91 and the lens portions 92.

The photoconductive materials 94a, 94b, and 95 may be a positive type material in which a portion exposed to light is decomposed and thereby becomes soluble in a developer or a negative type material in which a portion exposed to light is polymerized and thereby becomes insoluble in a developer. Examples of such photoconductive materials 94a, 94b, and 95 include a polyimide resin, a phenol-epoxy resin, an acrylic resin, a cycloolefin resin, etc.

In this exemplary embodiment, a polyimide resin is used. A description will be given below, assuming that a negative type material is used for the base 91, while a positive type material is used for the lens portion 92. In this exemplary embodiment, a polyimide precursor, which has not yet imidized, is also assumed to be a polyimide resin.

In order to form the lens portion 92 having a convex surface, grayscale lithography is employed.

Grayscale lithography is a lithographic method using a photomask 96 (see FIG. 8D). This photomask 96 has a light amount (exposure amount) distribution, and more specifically, the amount of light allowed to pass through the photomask 96 varies. The photomask 96 has a miniscule dot pattern 97 which does not produce a resolution with an exposure wavelength, and controls the transmission light amount in accordance with the density distribution of the dot pattern 97. If the density of the dot pattern 97 is low, the transmission light amount is large. If the density of the dot pattern 97 is high, the transmission light amount is small. The distribution of the dot pattern 97 is decided so that the surface configuration of the photoconductive material 95 which remains after being developed is formed into the convex lens portions 92 because of the difference in transmission light amount.

FIGS. 8A through 8E are sectional views illustrating a method for forming the lenses 90 (bases 91 and lens portions 92) of the light emitting chip C according to the first exemplary embodiment. A description will be given through the use of the light emitting thyristors L32, L33, L34, and L35. As shown in FIG. 7, the height s from the light emitting surface 311 to the vertex 92a of the lens 90 differs between the light emitting thyristor L32 and the light emitting thyristors L33, L34, and L35. More specifically, for the light emitting thyristor L32, the height s is the height s1. For the light emitting thyristors L33, L34, and L35, the height s is the height s2. The difference in the height s is set by changing the configuration of the base 91. In the light emitting thyristor L32, the base 91 is formed by only the base portion 91a, while in the thyristors L33 through L35, the base 91 is formed by stacking the base portions 91a and 91b.

The cross sections shown in FIGS. 8A through 8E correspond to the cross section of the light emitting thyristors L1 through L4 taken along line VIII-VIII of FIG. 6A, though the configuration of the base 91 differs between FIGS. 8A through 8E and FIG. 6A. The heights from the light emitting surface 311 to the vertexes 92a of the lenses 90 of the light emitting thyristors L1 through L4 in FIG. 6A are the same (height s1). In the light emitting thyristors L32 through L35 shown in FIGS. 8A through 8E, the heights s are different (height s1 and height s2).

A description will first be given of a method for forming the base 91. As shown in FIG. 7, the base 91 is formed by sequentially stacking the base portions 91a, 91b, 91c, and 91d. In FIGS. 8A through 8E, the forming method for the base 91 will be discussed through the use of the light emitting thyristors L32 through L35, and thus, a description will be given only of the base portions 91a and 91b.

FIG. 8A illustrates the light emitting chip C before the formation of the lenses 90.

As illustrated in FIG. 8B, the negative-type photoconductive material 94a is applied. Then, exposure light (not shown) to which the photoconductive material 94a is to be exposed is applied through a photomask (not shown) which is formed to allow a portion of the photoconductive material 94a which faces the light emitting surfaces 311 of the light emitting thyristors L1 through L128 to be exposed to light. Then, the portion of the photoconductive material 94a exposed to light is polymerized and thereby becomes insoluble in a developer. Subsequently, the photoconductive material 94a is immersed (developed) in a developer so that the portion of the photoconductive material 94a which has not been exposed to light (such a portion is not shown in FIG. 8B) is dissolved and removed and so that the polymerized portion (portion facing the light emitting surfaces 311 of the light emitting thyristors L1 through L128) remains. Then, the remaining portion of the photoconductive material 94a is heat-treated (baked) at a predetermined temperature so as to cause a solvent contained in the remaining portion to evaporate and also cause a polyimide precursor to imidize. With this action, the base portion 91a made of a polyimide resin is formed on the light emitting surfaces 311 of the light emitting thyristors L1 through L128.

As described above, the photomask is configured such that the base portion 91a faces the light emitting surfaces 311 of the light emitting thyristors L1 through L128. However, the photomask may be configured to form the base portion 91a over the entire light emitting chip C, except for at the terminals arranged on the light emitting chip C. The photomask may be configured to form the base portion 91a on part of the light emitting chip C so that the base portion 91a can be formed to face at least the light emitting surfaces 311 of the light emitting thyristors L1 through L128.

Additionally, the thickness of the photoconductive material 94a to be applied to the insulating layer 86 and the amount of exposure light are set so that the thickness of the portion of the photoconductive material 94a after being exposed to light and after being heat-treated becomes equal to the thickness of the base portion 91a.

Subsequently, as shown in FIG. 8C, the negative-type photoconductive material 94b is applied. In a manner similar to the formation of the base portion 91a, exposure light (not shown) is applied to the photoconductive material 94b through a photomask (not shown) configured to allow a portion of the photoconductive material 94b which faces the light emitting surfaces 311 of the light emitting thyristors L33 through L128 to be exposed to light, thereby forming the base portion 91b on the base portion 91a facing the light emitting surfaces 311 of the light emitting thyristors L33 through L128.

It is noted that the base portion 91a has already imidized after being heat-treated, and thus, it is not dissolved or deformed by the application of the photoconductive material 94b and immersion of the photoconductive material 94b in a developer.

Similarly, the base portion 91c is formed on the base portion 91b to face the light emitting surfaces 311 of the light emitting thyristors L65 through L128, and the base portion 91d is formed on the base portion 91c to face the light emitting surfaces 311 of the light emitting thyristors L97 through L128, through they are not shown.

As a result, the base 91 is formed.

The base portions 91a, 91b, 91c, and 91d are continuously provided along the light emitting thyristor array. However, they may be separately provided for the individual light emitting thyristors L.

In this exemplary embodiment, it is assumed that the base 91 is provided for each of the light emitting thyristors L, regardless of whether the bases 91 (base portions 91a through 91d) are continuously provided along the light emitting thyristor array or are separately provided for the individual light emitting thyristors L.

The base 91 is provided by stacking the base portions 91a through 91d. Alternatively, the base portion 91a may be provided for the light emitting thyristors L1 through L32, a base portion having a thickness equal to the total thickness of the base portions 91a and 91b may be provided for the light emitting thyristors L33 through L64, a base portion having a thickness equal to the total thickness of the base portions 91a, 91b, and 91c may be provided for the light emitting thyristors L65 through L96, and a base portion having a thickness equal to the total the thickness of the base portions 91a, 91b, 91c, and 91d may be provided for the light emitting thyristors L97 through L128.

A method for forming the lens portion 92 will be discussed below.

As shown in FIG. 8D, the positive-type photoconductive material 95 is applied onto the surface of the light emitting chip C on which the base 91 is formed, and exposure light 98 is applied to the photoconductive material 95 through the photomask 96.

On the surface of the substrate of the photomask 96, which is made of, for example, synthetic quartz having a high transmittance for the exposure light 98, the dot pattern 97, which is made of, for example, Cr, is provided to produce a distribution for the transmission light amount. That is, in accordance with a surface configuration having a convex shape of the lens portion 92, for the portion of the photoconductive material 95 which will be formed into the lens portion 92a and which will be positioned farther from the vertex 92a of the lens portion 92, a region of the dot pattern 97 having a lower density is applied. For the portion of the photoconductive material 95 which will not be formed into the lens portion 92, the dot pattern 97 is not provided for the photomask 96 so that the exposure light 98 can be applied to the photoconductive material 95.

The amount of the exposure light 98 is set so that the portion of the photoconductive material 95 which will not be formed into the lens portion 92 is to be developed and removed.

Then, as shown in FIG. 8E, the photoconductive material 95 which has become soluble in a developer due to the application of the exposure light 98 is removed by being immersed in a developer. As described above, a greater amount of light is applied to the portion of the photoconductive material 95 which will be formed into the lens portion 92 and which will be farther away from the vertex 92a of the lens portion 9, and thus, a greater amount of photoconductive material is removed.

Then, the photoconductive material 95 is heat-treated (baked) at a predetermined temperature so as to cause a solvent contained in the photoconductive material 95 to evaporate and also cause a polyimide precursor to imidize, thereby forming the lens portion 92 made of a polyimide resin.

It is noted that the base 91 has already imidized, and thus, it is not dissolved or deformed by the application of the photoconductive material 95 and immersion of the photoconductive material 95 in a developer.

With this method, the light emitting chip C including the lenses 90 (bases 91 and lens portions 92) is manufactured.

The transmission light amount of the photomask 96 used for grayscale lithography is controlled by the density distribution of the dot pattern 97 for blocking the exposure light 98. Alternatively, a dot pattern having dots of different sizes may be provided for controlling the transmission light amount, or a film for which the transmittance can be changed by adjusting its thickness may be provided, and the thickness of such a film may be changed.

The lenses 90 (bases 91 and lens portions 92) may be formed by, for example, an imprinting method.

In the imprinting method, a mold having a configuration of the lens 90 including the base 91 and the lens portion 92 is formed, and is pressed against a material which is to be formed into the lens 90.

If a thermoplastic resin is used as the material for the lens 90, the following thermal imprinting method is employed. A thermoplastic resin is applied onto the light emitting chip C without the lens 90, and a mold is pressed against the thermoplastic resin while the thermoplastic resin is being heated, thereby causing the thermoplastic resin to be deformed into the configuration of the mold. The thermoplastic resin is cooled so that it can be prevented from being deformed. Then, the mold is removed. With this method, the light emitting chip C including the lens 90 made of a thermoplastic resin is manufactured.

If a photo-curable resin is used as the material for the lens 90, the following optical imprinting method is employed. A mold is fabricated by using fused quartz that transmits ultraviolet rays for curing the photo-curable resin. Then, a photo-curable resin is applied onto the light emitting chip C without the lens 90, and is irradiated with light through the mold while the mold is being pressed against the photo-curable resin. After the photo-curable rein is cured, the mold is removed. With this method, the light emitting chip C including the lens 90 made of a photo-curable resin is manufactured.

### Operation of Light Emitting Device 65

The operation of the light emitting device 65 will be discussed below.

As described above, the light emitting device 65 includes the light emitting chips C1 through C40 (see FIGS. 3 and 4B).

As shown in FIG. 4B, the reference potential Vsub and the power supply potential Vga are supplied to all the light emitting chips C on the circuit board 62. Similarly, the first transfer signal φ1 and the second transfer signal φ2 are transmitted to the light emitting chips C1 through C40 in parallel.

In contrast, the lighting signals φI1 through φI40 are individually supplied to the light emitting chips C1 through C40, respectively. The lighting signals φI1 through φI40 are signals to turn ON or OFF the light emitting thyristors L of the light emitting chips C1 through C40 on the basis of image data. Accordingly, the waveforms of the lighting signals φI1 through φI40 are different from one another depending on the image data. However, the lighting signals φI1 through φI40 are transmitted at the same time in parallel.

Since the light emitting chips C1 through C40 are driven in parallel, a description will be given only of the operation of the light emitting chip C1.

### (Thyristor)

Before describing the operation of the light emitting chip C1, a basic operation of thyristors (transfer thyristors T and light emitting thyristors L) will be discussed first. The thyristor is a semiconductor device having three terminals, i.e., an anode terminal, a cathode terminal, and a gate terminal.

A description will be given below, by way of example, assuming that the reference potential Vsub supplied to the backside electrode 85 (see FIGS. 5 through 6B), which is the Vsub terminal, is 0 V as a high level potential (hereinafter simply designated by “H”), and that the power supply potential Vga supplied to the Vga terminal is −3.3 V as a low potential (hereinafter simply designated by “L”).

In this exemplary embodiment, the light emitting device 65 is driven by a negative potential.

The p-type first semiconductor layer 81, which serves as the anode terminal of the thyristor, is at the same potential as the p-type substrate 80, and is thus at the reference potential Vsub (“H” (0 V)) supplied to the backside electrode 85.

The thyristor is formed, as shown in FIG. 6B, by stacking semiconductor layers made of, for example, GaAs or GaAlAs, i.e., the p-type semiconductor layers (p-type first and third semiconductor layers 81 and 83) and n-type semiconductor layers (n-type second and fourth semiconductor layers 82 and 84), on the p-type substrate 80. A description will be given below, assuming that the forward potential (diffusion potential) Vd of the p-n junction including a p-type semiconductor layer and an n-type semiconductor layer is 1.5 V.

In a thyristor in the OFF state in which a current does not flow between the anode terminal and the cathode terminal, if a potential lower than a threshold potential, i.e., a negative potential having a large absolute value, is applied to the cathode terminal, the thyristor is changed to the ON state (turned ON). The threshold voltage of the thyristor is the value obtained by subtracting the forward potential Vd (1.5 V) of the p-n junction from the potential of the gate terminal. Accordingly, if the potential of the gate terminal is 0 V, the threshold voltage of the thyristor is −1.5 V. That is, if a potential lower than −1.5 V, i.e., a negative potential having a large absolute value, is applied to the cathode terminal, the thyristor is turned ON, thereby causing a current to flow between the anode terminal and the cathode terminal (ON state).

The potential of the gate terminal of the ON state thyristor is close to the potential of the anode terminal. Since the anode terminal is set at the reference potential Vsub (0 V (“H”)), the potential of the gate terminal is 0 V (“H”). The potential of the cathode terminal of the ON state thyristor is close to a potential obtained by subtracting the forward potential Vd (1.5 V) of the p-n junction from the potential of the anode terminal. Since the anode terminal is set at the reference potential Vsub (0 V (“H”)), the potential of the cathode terminal of the ON-state thyristor is close to −1.5 V, i.e., a negative potential having an absolute value larger than 1.5 V. The potential of the cathode terminal is set in accordance with the relationship with the power source for supplying a current to the ON-state thyristor.

Once the thyristor is turned ON, if a potential, i.e., a negative potential having a small absolute value, 0 V, or a positive potential, higher than a potential, i.e., a potential close to −1.5 V, necessary for the thyristor to be maintained in the ON state is applied to the cathode terminal, the thyristor is changed to the OFF state (turned OFF). For example, if the cathode terminal is changed to “H” (0 V), the thyristor is turned OFF since the potential of the cathode terminal is a potential higher than the potential necessary for the thyristor to be maintained in the ON state and since the cathode terminal and the anode terminal are at the same potential.

In contrast, if a potential, i.e., a negative potential having a large absolute value, lower than the potential necessary for the thyristor to be maintained in the ON state is intermittently applied to the cathode terminal of the ON state thyristor, and if a current for allowing the thyristor to be maintained in the ON state is supplied to the ON-state thyristor, the thyristor is maintained in the ON state.

When the light emitting thyristor L is turned ON, it lights up (emits light). If the light emitting thyristor L is turned OFF, it lights off. The amount of light emitted from the light emitting thyristor L in the ON state is determined by the area of the light emitting surface 311 and the current flowing between the cathode terminal and the anode terminal.

### (Timing Chart)

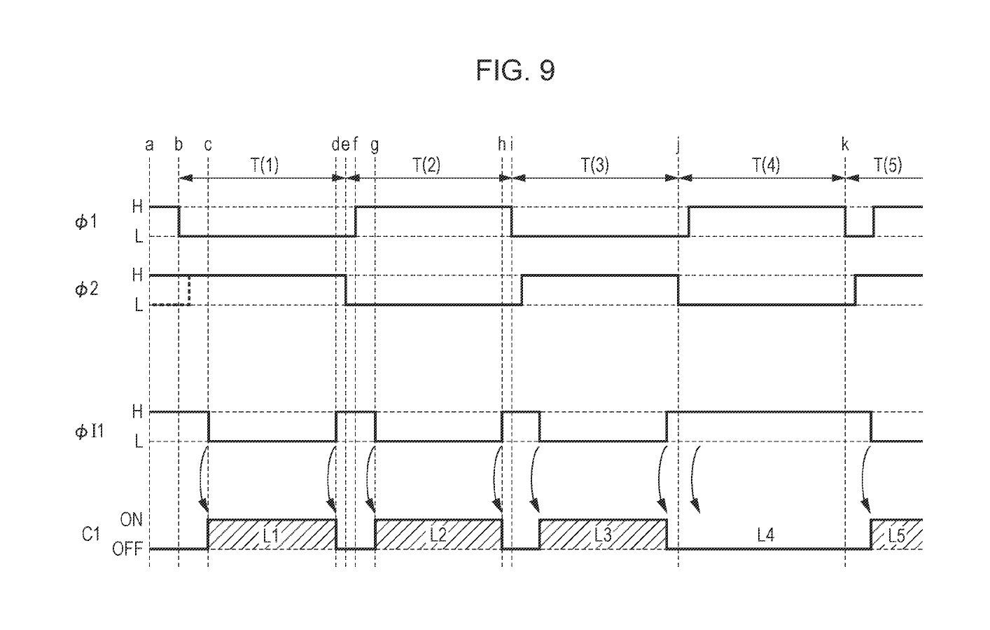

FIG. 9 is a timing chart illustrating the operations of the light emitting device 65 and the light emitting chips C.

FIG. 9 is a timing chart for a control operation for controlling ON/OFF of the five light emitting thyristors L1 through L5 of the light emitting chip C (such a control operation is referred to as the “lighting control operation”). As stated above, the light emitting chips C2 through C40 are operated in parallel with the light emitting chip C1. Accordingly, a description will be given only of the light emitting chip C1.

In FIG. 9, the light emitting thyristors L1, L2, L3, and L5 of the light emitting chip C1 are turned ON, while the light emitting thyristor L4 is turned OFF (not light up).

In FIG. 9, the time elapses from time a to time k in alphabetical order. The ON/OFF operation of the light emitting thyristor L1 is controlled during period T(1) from time b to time e, the ON/OFF operation of the light emitting thyristor L2 is controlled during period T(2) from time e to time i, the ON/OFF operation of the light emitting thyristor L3 is controlled during period T(3) from time i to time j, and the ON/OFF operation of the light emitting thyristor L4 is controlled during period T(4) from time j to time k. Thereafter, the ON/OFF operation of the light emitting thyristors L5 and the subsequent light emitting thyristors is similarly controlled.

The periods T(1), T(2), T(3), etc. have the same period of time, and are referred to as the “period T” when they are not distinguished from one another.

The periods T(1), T(2), T(3), etc. may be variable if the relationships among the signals which will be described below are maintained.

The waveforms of the first transfer signal φ1, the second transfer signal φ2, and the lighting signal φI1 are as follows. During the period from time a to time b, the light emitting chip C1 (and also light emitting chips C2 through C40) starts to operate. The signals during this period will be discussed together with a description of the operation of the light emitting chip C.

The first and second transfer signals φ1 and φ2 respectively transmitted to the φ1 and φ2 terminals (see FIGS. 5 and 6A) each have two potentials “H” and “L”. The waveforms of the first and second transfer signals φ1 and φ2 are repeated in units of waveforms contained in two continuous periods (e.g., periods T(1) and T(2)).

The first transfer signal φ1 shifts from “H” to “L” at time b at the start of the period T(1) and shifts from “L” to “H” at time f, and then shifts from “H” to “L” at time i at the end of the period T(2).

The second transfer signal φ2 is at “H” at time b at the start of the period T(1) and shifts from “H” to “L” at time e, and is maintained at “L” until time i at the end of the second period T(2).

By comparing the first and second transfer signals φ1 and φ2, the second transfer signal φ2 is displaced from (later than) the first transfer signal φ1 by an amount equal to period T on the time axis. Concerning the first transfer signal φ1, the waveform in the periods T(1) and T(2) is repeated after the period T(3). Concerning the second transfer signal φ2, the waveform indicated by the broken lines in the period T(1) and the waveform in the period T(2) are repeated after the period T(3). The reason why the waveform of the second transfer signal φ2 in the period T(1) is different from that after the period T(3) is because the light emitting device 65 starts to operate in the period T(1).

A pair of first and second transfer signals φ1 and φ2 propagate the ON state to the transfer thyristors T shown in FIGS. 5 and 6A in numerical order, thereby specifying the light emitting thyristors L designated by the same numbers as the ON-state transfer thyristors to be subjected to the ON/OFF control operation (lighting control) operation). This will be described later.

The lighting signal φI1 to be transmitted to the φI terminal of the light emitting chip C will be discussed below. The lighting signals φI2 through φI40 are transmitted to the light emitting chips C2 through C40, respectively. The lighting signal φI1 has two potentials, i.e., “H” and “L”.

The lighting signal φI1 will be described by use of the lighting signal φI1 in the period T(1) for which the lighting control operation is performed on the light emitting thyristor L1 of the light emitting chip C1. The light emitting thyristor L1 lights up (turned ON).

The lighting signal φI1 remains at “H” at time b at the start of the period T(1) and shifts from “H” to “L” at time c. The lighting signal φI1 then shifts from “L” to “H” at time d and is maintained at “H” at time e at the end of the period T(1).

The operations of the light emitting device 65 and the light emitting chip C1 will be discussed below with reference to the timing chart of FIG. 9 while also referring to FIGS. 4B and 5. A description will be given of the operations of the light emitting device 65 and the light emitting chip C1 in the periods T(1) and T(2).

### (1) Time A

### (Light Emitting Device 65)

At time a, the reference potential supply section 160 of the signal generating circuit 110 of the light emitting device 65 sets the reference potential Vsub at “H” (0 V). The power supply potential supply section 170 sets the power supply potential Vga at “L” (−3.3 V). Then, the power supply line 200a on the circuit board 62 of the light emitting device 65 is set at “H” (0 V), which is the reference potential Vsub, and the Vsub terminal of each of the light emitting chips C1 through C40 is set at “H”. Similarly, the power supply line 200b is set at “L” (−3.3 V), which is the power supply potential Vga, and the Vga terminal of each of the light emitting chips C1 through C40 is at “L” (see FIG. 4B). As a result, the power supply line 71 of each of the light emitting chips C1 through C40 is at “L” (see FIG. 5).

Then, the transfer signal generator 120 of the signal generating circuit 110 sets the first transfer signal φ1 and the second transfer signal φ2 at “H”. Then, the first and second transfer signal lines 201 and 202 are also made to be at “H” (see FIG. 4B). This causes the φ1 and φ2 terminals of each of the light emitting chips C1 through C40 to be at “H”. The potentials of the first and second transfer signal lines 72 and 73 respectively connected to the φ1 and φ2 terminals through the current regulating resistors R1 and R2 are also made to be at “H” (see FIG. 5).

The lighting signal generator 140 of the signal generating circuit 110 sets the lighting signals φI1 through φI40 to be “H”. Then, the lighting signal lines 204-1 through 204-40 are made to be at “H” (see FIG. 4B). This causes the φI terminals of the light emitting chips C1 through C40 to be at “H” through the current regulating resistor RI, thereby further causing the lighting signal line 75 connected to the φI terminal to be at “H” (see FIG. 5).

The operation of the light emitting chip C will be discussed below.

The following description will be given with reference to FIG. 9, assuming that the potentials of the terminals are changed in a step-like manner. Actually, however, they are gradually changed. Accordingly, even while the potential is in the process of changing, if the following conditions are satisfied, the state may be changed by causing the thyristor to be turned ON or OFF.

### (Light Emitting Chip C1)

The anode terminals of the transfer thyristor T and the light emitting thyristor L are set to be at “H” (0 V) since they are connected to the Vsub terminal.

The cathode terminals of the odd-numbered transfer thyristors T1, T3, T5, etc. are connected to the first transfer signal line 72 and are set at “H”. The cathode terminals of the even-numbered transfer thyristors T2, T4, T6, etc. are connected to the second transfer signal line 73 and are set at “H”. Accordingly, the transfer thyristor T is in the OFF state since both the anode terminal and the cathode terminal are at “H”.

The cathode terminal of the light emitting thyristor L is connected to the lighting signal line 75 which is at “H”. Accordingly, the light emitting thyristor L is also in the OFF state since both the anode terminal and the cathode terminal are at “H”.

As stated above, the gate terminal Gt1 at one end of the transfer thyristor array in FIG. 5 is connected to the cathode terminal of the start diode Dx0. The gate terminal Gt1 is also connected to the power supply line 71 of the power supply potential Vga (“L” (−3.3 V)) through the power supply line resistor Rgx1. The anode terminal of the start diode Dx0 is connected to the second transfer signal line 73 and is also connected to the φ2 terminal, which is set at “H” (0 V), through the current regulating resistor R2. Thus, the start diode Dx0 is forward biased, and the cathode terminal (gate terminal Gt1) of the start diode Dx0 is set at the potential (−1.5 V) obtained by subtracting the forward potential Vd (1.5 V) of the p-n junction from the potential (“H” (0 V)) of the anode terminal of the start diode Dx0. When the gate terminal Gt1 is set at −1.5 V, the coupling diode Dx1 is forward biased since the anode terminal (gate terminal Gt1) of the coupling diode Dx1 is −1.5 V and since the cathode terminal thereof is connected to the power supply line 71 (“L” (−3.3 V)) through the power supply line resistor Rgx2. Accordingly, the potential of the gate terminal Gt2 is −3 V obtained by subtracting the forward potential Vd (1.5 V) of the p-n junction from the potential (−1.5 V) of the gate terminal Gt1. However, the gate terminal Gt3 and the subsequent gate terminals are not influenced by the fact that the anode terminal of the start diode Dx0 is at “H” (0 V), and thus, the potentials of the gate terminal Gt3 and the subsequent gate terminals are maintained at “L” (−3.3 V), which is the potential of the power supply line 71.

Since the gate terminals Gt are connected to the gate terminals Gl, the gate terminals Gl are at the same potential as the gate terminals Gt. Thus, the threshold voltage of the transfer thyristor T is the potential obtained by subtracting the forward potential Vd (1.5 V) of the p-n junction from the gate terminal Gt, and similarly, the threshold voltage of the light emitting thyristor L is the potential obtained by subtracting the forward potential Vd (1.5 V) of the p-n junction from the gate terminal Gl. That is, the threshold voltages of the transfer thyristor T1 and the light emitting thyristor L1 are −3 V, the threshold voltages of the transfer thyristor T2 and the light emitting thyristor L2 are −4.5 V, and the threshold voltages of the transfer thyristor T3 and the subsequent transfer thyristors and the light emitting thyristors L3 and the subsequent light emitting thyristors are −4.8 V.

### (2) Time B

At time b shown in FIG. 9, the first transfer signal φ1 shifts from “H” (0 V) to “L” (−3.3 V). Then, the light emitting device 65 starts to operate.

The first transfer signal φ1 shifts from “H” to “L”, and then, the potential of the first transfer signal line 72 shifts from “H” to “L” through the φ1 terminal and the current regulating resistor R1. Then, the transfer thyristor T1 for which the threshold voltage is −3 V is turned ON. However, the transfer thyristors T3 and the subsequent odd-numbered transfer thyristors T whose cathode terminals are connected to the first transfer signal line 72 are not turned ON since the threshold voltages of such transfer thyristors T are −4.8 V. The even-numbered transfer thyristors T are not turned ON since the second transfer signal φ2 is at “H” (0 V) and since the second transfer signal line 73 is at “H”.

Because of the turning ON of the transfer thyristor T1, the potential of the first transfer signal line 72 is set at −1.5 V obtained by subtracting the forward potential Vd (1.5 V) of the p-n junction from the potential (“H” (0 V)) of the anode terminal.

Because of the turning ON of the transfer thyristor T1, the potential of the gate terminal Gt1 (gate terminal Gl1) is set at “H” (0 V), which is the potential of the anode terminal of the transfer thyristor T1. The potential of the gate terminal Gt2 (gate terminal Gl2) is −1.5 V, the potential of the gate terminal Gt3 (gate terminal Gl3) is −3 V, and the potential of the gate terminal Gt4 and the subsequent gate terminals (gate terminals Gl) is at “L” (−3.3 V).

Accordingly, the threshold voltage of the light emitting thyristor L1 is −1.5 V, the threshold voltages of the transfer thyristor T2 and the light emitting thyristor L2 are −3 V, the threshold voltages of the transfer thyristor T3 and the light emitting thyristor L3 are −4.5 V, and the threshold voltages of the transfer thyristor T4 and the subsequent transfer thyristors and the light emitting thyristor L4 and the subsequent light emitting thyristors are −4.8 V.

However, since the first transfer signal line 72 is set at −1.5 V because of the turning ON of the transfer thyristor T1, the odd-numbered transfer thyristors in the OFF state are not turned ON. Since the second transfer signal line 73 is at “H”, the even-numbered transfer thyristors T are not turned ON. Since the lighting signal line 75 is at “H”, the light emitting thyristors L are not turned ON.

Immediately after time b (after the state of the thyristor is changed due to a change in the potential of the signal at time b, and when such a state becomes constant) the transfer thyristor T1 is in the ON state, and the other transfer thyristors T and all the light emitting thyristors L are in the OFF state.

### (3) Time C

At time c, the lighting signal φI1 shifts from “H” to “L”.

The transition of the lighting signal φI1 from “H” to “L” causes the lighting signal line 75 to shift from “H” to “L” via the current regulating resistor R1 and the φI terminal. Then, the light emitting thyristor L1 having a threshold of −1.5 V is turned ON and lights up (emits light). This changes the potential of the lighting signal line 75 to a potential close to −1.5 V, i.e., a negative potential having an absolute value larger than 1.5 V. The light emitting thyristor L2 having a threshold of −3 V is not turned ON because the potential of the lighting signal 75 has become close to −1.5 V due to the turning ON of the light emitting thyristor L1 having a potential as high as −1.5 V.

Immediately after time c, the transfer thyristor T1 is in the ON state, and the light emitting thyristor L1 is also in the ON state and accordingly lights up (emits light).

### (4) Time D

At time d, the lighting signal φI1 shifts from “L” to “H”.

The transition of the lighting signal φI1 from “L” to “H” causes the potential of the lighting signal line 75 to shift from “L” to “H” via the current regulating resistor R1 and the φI terminal. Then, the light emitting thyristor L1 is turned OFF (not light up) since both the anode terminal and the cathode terminal are changed to “H”. The period for which the light emitting thyristor L is in the ON state is a period for which the lighting signal φII is at “L” from time c when the lighting signal φI1 shifts from “H” to “L” until time d when the lighting signal φI1 shifts from “L” to “H”.

Immediately after time d, the transfer thyristor T1 is in the ON state.

### (5) Time E

At time e, the second transfer signal φ2 shifts from “H” to “L”. Then, the period T(1) for which the ON/OFF operation of the light emitting thyristor L1 is controlled has finished, and then, the period T(2) for which the ON/OFF operation of the light emitting thyristor L2 is started.

The transition of the second transfer signal φ2 from “H” to “L” causes the potential of the second transfer signal line 73 to shift from “H” to “L” via the φ2 terminal. Since the threshold voltage of the transfer thyristor T2 is −3 V, as stated above, the transfer thyristor T2 is turned ON. Thus, the potential of the gate terminal Gt2 (gate terminal Gl2) is “H” (0 V), the potential of the gate terminal Gt3 (gate terminal Gl3) is −1.5 V “H” (0 V), the potential of the gate terminal Gt4 (gate terminal Gl4) is −3V, and the potentials of the gate terminal Gt5 and the subsequent gate terminals are −3.3 V.

Immediately after time e, the transfer thyristors T1 and T2 are in the ON state.

### (6) Time F

At time f, the first transfer signal φ1 shifts from “L” to “H”.

The transition of the first transfer signal φ1 from “L” to “H” causes the potential of the first transfer signal line 72 to shift from “L” to “H” via the φ1 terminal. The transfer thyristor T1 in the ON state is then turned OFF since the anode terminal and the cathode terminal are both changed to “H”. Then, the potential of the gate terminal Gt1 (gate terminal Gl1) changes toward the power supply potential Vga (“L” (−3.3 V)) of the power supply line 71 via the power supply line resistor Rgx1. This causes the coupling diode Dx1 to be in the state in which a potential is applied in the direction in which a current does not flow in the coupling diode Dx1. That is, the coupling diode Dx1 is reverse biased. Accordingly, the fact that the gate terminal Gt2 (gate terminal Gl2) is at “H” (0 V) does not influence the gate terminal Gt1 (gate terminal Gl1). That is, the threshold voltage of the transfer thyristors T whose gate terminals Gt are connected to the reverse-biased coupling diode Dx is changed to −4.8 V, and such transfer thyristors T are not turned ON by the transmission of the first transfer signal φ1 or the second transfer signal φ2 having a potential “L” (−3.3 V).

Immediately after time f, the transfer thyristor T2 is in the ON state.

### (7) Others

At time g, the lighting signal φI1 shifts from “H” to “L”, and then, the light emitting thyristor L2 is turned ON and lights up (emits light), as in the light emitting thyristor L1 at time c.

At time h, the lighting signal φI1 shifts from “L” to “H”, and then, the light emitting thyristor L2 is turned OFF and lights off, as in the light emitting thyristor L1 at time d.

At time i, the first transfer signal φ1 shifts from “H” to “L”, and then, the transfer thyristor T3 having a threshold of −3 V is turned ON, as in the transfer thyristor T1 at time b or the transfer thyristor T2 at time e. At time i, the period T(2) for which the ON/OFF operation of the light emitting thyristor L2 is controlled has finished, and the period T(3) for which ON/OFF operation of the light emitting thyristor L3 is started.

Thereafter, the above-described operation is repeated.

If the light emitting thyristor L is caused to remain OFF (not light up) instead of lighting it up (emitting it light), the lighting signal φI remains at “H” (0 V), as in the lighting signal φI1 in the period T(4) from time j to time k in which the ON/OFF operation of the light emitting thyristor L4 is controlled. With this operation, even if the threshold of the light emitting thyristor L4 is −1.5 V, the light emitting thyristor L4 remains OFF (not light up).

As described above, the gate terminals Gt of the transfer thyristors T are connected to one another with the coupling diodes Dx therebetween. Accordingly, when the potential of one gate terminal Gt is changed, the potential of another gate terminal Gt connected, via the forward-biased coupling diode Dx, to the gate terminal Gt whose potential has been changed is also changed. Then, the threshold voltage of the transfer thyristor T having a gate terminal for which the potential has been changed is changed. If the threshold voltage of the transfer thyristor T is a value higher than “L” (−3.3 V), i.e., a negative value having a small absolute value, the transfer thyristor T is turned ON when the first transfer signal φ1 or the second transfer signal φ2 shifts from “H” (0 V) to “L” (−3.3 V).

Since the threshold voltage of the light emitting thyristor L whose gate terminal Gl is connected to the gate terminal Gt of the ON state transfer thyristor T is −1.5 V, the light emitting thyristor L is turned ON and lights up (emits light) when the lighting signal φI shifts from “H” to “L”.

That is, when the transfer thyristor T is turned ON, it specifies the light emitting thyristor L which is to be subjected to the lighting control operation, and the lighting signal φI controls the ON/OFF state of the light emitting thyristor L.

In this manner, the waveform of the lighting signal φI is set in accordance with image data so as to control the ON/OFF state of each of the light emitting thyristors L.

### Lens 90

The lenses 90 in the first exemplary embodiment will be discussed below.

In the first exemplary embodiment, as shown in FIG. 7, the height s from the light emitting surface 311 to the vertex 92a of the lens 90 varies among the light emitting thyristors by changing the thickness (height from the light emitting thyristor L to the boundary between the base 91 and the lens portion 92) of the base 91. More specifically, the height s of the light emitting thyristor group I (light emitting thyristors L1 through L32) is set to be the height s1. The height of the light emitting thyristor group II (light emitting thyristors L33 through L64) is set to be the height s2. The height s of the light emitting thyristor group III (light emitting thyristors L65 through L96) is set to be the height s3. The height s of the light emitting thyristor group IV (light emitting thyristors L97 through L128) is set to be the height s4. A larger height s is set for the light emitting thyristor which is positioned farther from the φI terminal used for supplying a current for turning ON the light emitting thyristor L.

The reason for the setting of the height s in this manner will be discussed below.

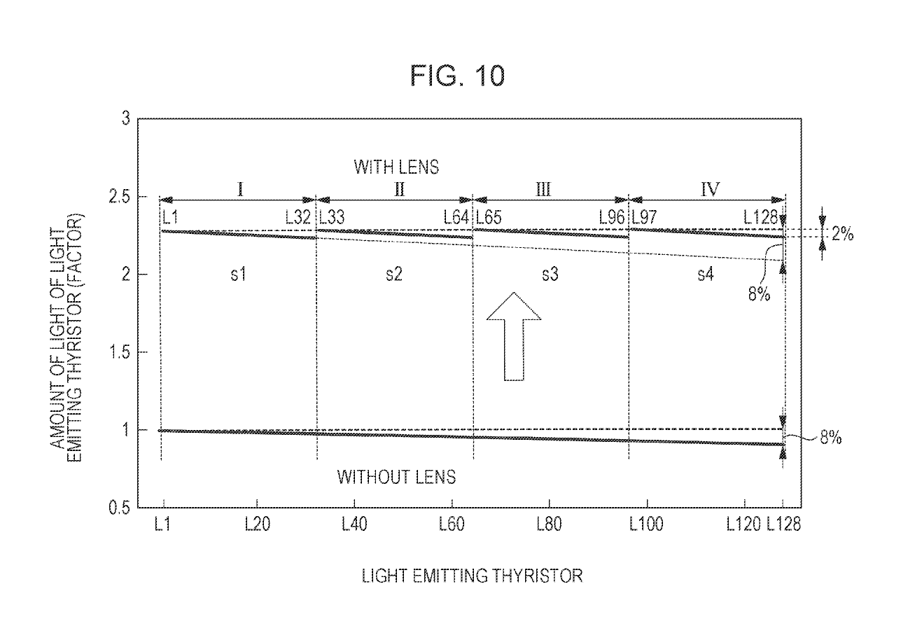

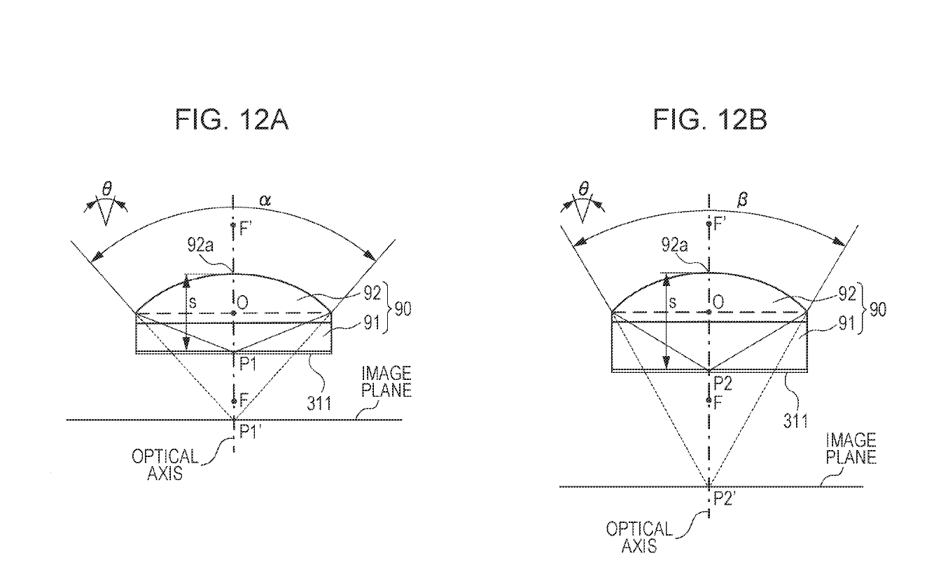

FIG. 10 illustrates the amounts of light of the light emitting thyristors L of the light emitting chip C according to the first exemplary embodiment. The amounts of light of the light emitting thyristors L are expressed by numerical values, assuming that the amount of light of the light emitting thyristor L1 without the lens 90 is 1. As will be described below, the amount of light is, among the amount of light emitted from the light emitting thyristor L, an amount of light which is incident in a range of the angular aperture θ of the rod lens array 64 and which allows the photoconductor drum 12 to be exposed to light (irradiates the photoconductor drum 12) (see FIGS. 12A and 12B).

As indicated by “WITHOUT LENS” in FIG. 10, the amount of light of the light emitting thyristor L gradually decreases as the light emitting thyristor L number increases. This is because the φI terminal used for supplying a current for turning ON the light emitting thyristors L to the lighting signal line 75 is provided near the light emitting thyristor L (see FIGS. 5 and 6A). That is, the resistance (value) of a portion in the lighting signal line 75 (trunk portion 75a) through which the current for turning ON the light emitting thyristor L flows is different from that of another portion in the lighting signal line 75. The resistance of the portion in the lighting signal line 75 increases as the light emitting thyristor L number increases.

Since light emitting thyristors L are arranged at regular intervals, the amount of an increase in the resistance (value) every time the light emitting thyristor L number is incremented by one is uniform. Accordingly, if the resistance (value) between the anode terminal and the cathode terminal of the light emitting thyristor L is constant, the current flowing in the light emitting thyristor L is inversely proportional to the light emitting thyristor L number (position). Accordingly, if the amount of light of the light emitting thyristor L is proportional to the current flowing in the light emitting thyristor L, it is inversely proportional to the light emitting thyristor L number (position). That is, as the light emitting thyristor L number increases, the amount of light of the light emitting thyristor L decreases.

For simple representation, in FIG. 10, the amount of light of the light emitting thyristor L linearly decreases with respect to the light emitting thyristor L number (position).

FIG. 10 shows that the amount of light of the light emitting thyristor L128 is smaller than that of the light emitting thyristor L1 by 8%.

The amount of light of the light emitting thyristor L “WITH LENS” shown in FIG. 10 will be discussed later.

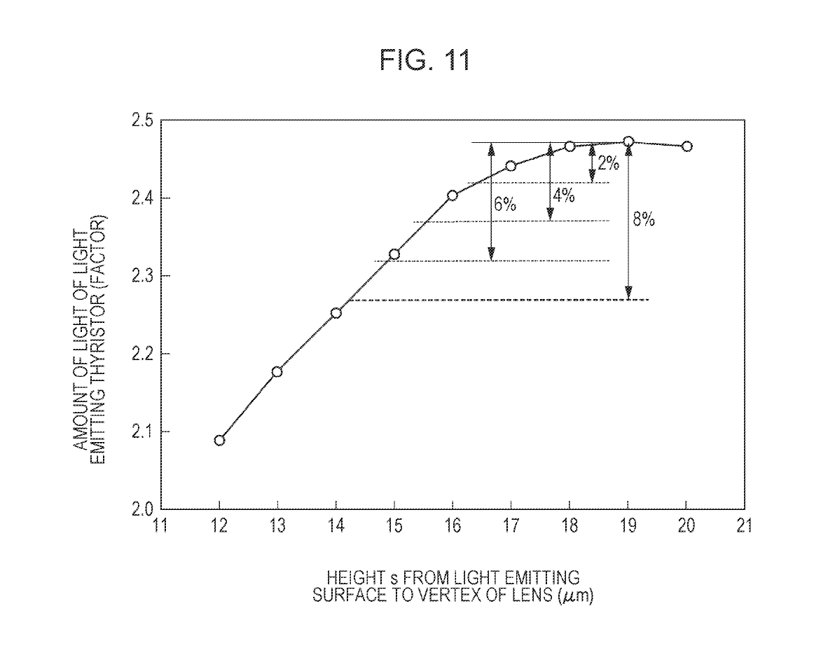

FIG. 11 illustrates an example of a change in the amount of light in the light emitting thyristor L provided with the lens 90, and more specifically, a change in the amount of light with respect to the height s from the light emitting surface 311 to the vertex 92a of the lens 90. In this example, it is also assumed that the amount of light of the light emitting thyristor L without the lens 90 is 1. This light emitting thyristor L is the light emitting thyristor L1 which is less influenced by the resistance (value) of the lighting signal line 75 (trunk portion 75a) than the other light emitting thyristors L.

As shown in FIG. 11, when the height s from the light emitting surface 311 to the vertex 92a of the lens 90 ranges from 12 to 19 μm, the amount of light of the light emitting thyristor L increases as the height s increases. Conversely, when the height s exceeds 19 μm, the amount of light of the light emitting thyristor L1 decreases.

That is, in this example, if the base 91 is provided so that the height s is 19 μm, the amount of light of the light emitting thyristor L increases to a greater level than the light emitting thyristor L without the lens 90 by a factor of 2.47.

The amount of light which is reduced by 8% from the amount of light when the height s is 19 μm is an amount of light (a factor of 2.28) when the height s is 14.3 μm.

As described above, if the lenses 90 are provided such that they face the light emitting surfaces 311 of the light emitting thyristors L, the amount of light which is incident on the rod lens array 94 and which allows the photoconductor drum 12 to be exposed to light increases. Then, an increase in the amount of light varies in accordance with the height s from the light emitting surface 311 to the vertex 92a of the lens 90. Thus, an increase in the amount of light is set by adjusting the height s, and more specifically, by adjusting the thickness of the base 91 (height from the light emitting thyristor L to the boundary between the base 91 and the lens portion 92).

FIGS. 12A and 12B are schematic views illustrating that the amount of light of the light emitting thyristor L changes in accordance with the height s from the light emitting surface 311 to the vertex 92a of the lens 90.

In FIGS. 12A and 12B, the relationship between the light emitting surface 311 of the light emitting thyristor L and the lens 90 is illustrated by a cross section including the optical axis (line passing through the principal point O and the focal points F and F′, which will be discussed). In FIGS. 12A and 12B, the insulating layer 86, the n-type ohmic electrode 321, and the branch portion 75b of the lighting signal line 75 are not shown.

The principal point O is set, assuming that the front principal point and the rear principal point of the lens portion 92 coincide with each other. It is also assumed that the distance from the focal point F to the principal point O is equal to that from the focal point F′ to the principal point O.

The light emitting surface 311 is positioned between the principal point O and the focal point F of the lens portion 92. That is, the lens 90 functions as magnifying glass.

FIG. 12A illustrates that the thickness of the base 91 is smaller than that shown in FIG. 12B. Because of a small thickness of the base 91, the height s from the light emitting surface 311 to the vertex 92a of the lens 90 is small. Accordingly, concerning the relationship between the focal point F and the principal point O of the lens portion 92, the light emitting surface 311 is closer to the principal point O than to the focal point F.

In contrast, FIG. 12B illustrates that the thickness of the base 91 is larger than that shown in FIG. 12A. Because of a large thickness of the base 91, the height s from the light emitting surface 311 to the vertex 92a of the lens 90 is large. Accordingly, concerning the relationship between the focal point F and the principal point O of the lens portion 92, the light emitting surface 311 is closer to the focal point F than to the principal point O.

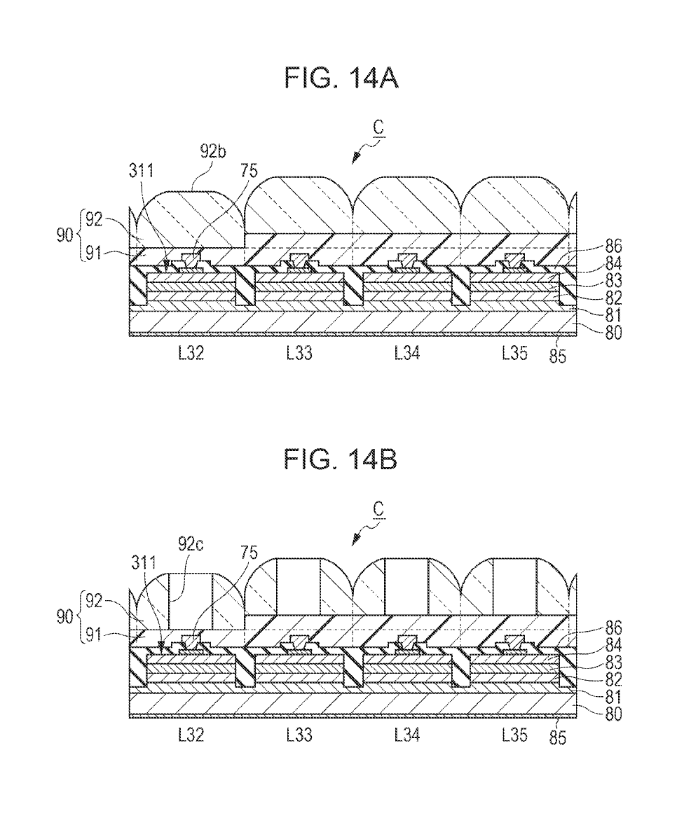

In FIGS. 14A and 14B, the optical path changes in the principal plane (indicated by the broken lines in FIGS. 14A and 14B) which passes through the principal point O and which is perpendicular to the optical axis (passing through the principal point O and the focal points F and F′).

Light emitted from the light emitting surface 311 of the light emitting thyristor L is incident on the rod lens array 64 having the angular aperture θ via the lens 90, and allows the photoconductor drum 12 to be exposed to light. That is, light which extend beyond the angular aperture θ is not input into the rod lens array 64. Thus, the amount of light incident in a range within the angular aperture θ is an amount of light which allows the photoconductor drum 12 to be exposed.

A description will be given below by focusing on one lens 90 corresponding to one light emitting thyristor L. Even if light emitted from the light emitting surface 311 of a light emitting thyristor L is incident on the lens 90 of an adjacent light emitting thyristor L, light is output from the lens 90 at an angle greater than the angular aperture θ, and thus, it is not input into the rod lens array 64. Accordingly, the amount of light of the light emitting thyristor L input into the rod lens array 94 will be discussed by focusing on only one lens 90 corresponding to one light emitting thyristor L.

As shown in FIG. 12A, light emitted from the light emitting point P1 at the center of the light emitting surface 311 via the lens 90 (including the base 91 and the lens portion 92) appears as if it is output from the image point P1′ on the image plane. That is, light emitted from the light emitting point P1 is output within a range of an angle α from the lens 90. Then, as is apparent from FIG. 12A, light emitted from the light emitting point P1 is focused in the direction of the optical axis because of the provision of the lens 90. Thus, the amount of light input into a range of the angular aperture θ increases compared with a light emitting thyristor without the lens 90.

As shown in FIG. 12B, the thickness of the base 91 is larger than that shown in FIG. 12A, and the height s from the light emitting surface 311 to the vertex 92a of the lens 90 is larger than that shown in FIG. 12A. In this case, light emitted from the light emitting point P2 appears as if it is output from the image point P2′ on the image plane. That is, light emitted from the light emitting point P2 at the center of the light emitting surface 311 is output within a range of an angle β from the lens 90. The angle β is smaller than the angle α shown in FIG. 12A. Thus, the amount of light input into a range of the angular aperture θ is greater than that in the case of the angle α.

Thus, when the height s from the light emitting surface 311 to the vertex 92a of the lens 90 ranges from 12 to 19 μm, as shown in FIG. 11, as the height s increases, the amount of light input into a range of the angular aperture θ increases. However, if the height s further increases in excess of 19 μm, the light emitting point (P1 in FIG. 12A or P2 in FIG. 12B) is positioned closer to the focal point F. Then, the lens 90 (lens portion 92) does not function as magnifying glass, and the amount of light input into a range of the angular aperture θ decreases.

That is, by changing the height s from the light emitting surface 311 to the vertex 92a of the lens 90, the amount of light input into the angular aperture θ changes.

In the first exemplary embodiment, therefore, a variation in the amount of light among the light emitting thyristors L caused by a difference in the resistance (value) of portions of the lighting signal line 75 (trunk portion 75a) through which a current for turning ON the light emitting thyristors L flows is compensated for by a change in the height s from the light emitting surface 311 to the vertex 92a of the lens 90. Thus, the occurrence of a variation in the amount of light among the light emitting thyristors L is suppressed.

More specifically, in the case of the light emitting thyristors L without the lens 90, the length of the path in the lighting signal line 75 (trunk portion 75a) through which the lighting signal φI flows varies. Accordingly, as the light emitting thyristor L number increases, the resistance (value) of the path in the lighting signal line 75 (trunk portion 75a) increases. Thus, as the light emitting thyristor L number increases, the amount of light of the light emitting thyristor L decreases.

In the case of the light emitting thyristors L “WITHOUT LENS” shown in FIG. 10, the amount of light of the light emitting thyristor L128 is smaller than that of the light emitting thyristor L1 by 8%. In the case of the light emitting thyristors L “WITH LENS”, too, if the height s from the light emitting surface 311 to the vertex 92a of the lens 90 is uniform, a variation of 8% in the amount of light between the light emitting thyristors L1 and L128 also occurs.

Thus, in order to compensate for this variation, the height s from the light emitting surface 311 to the vertex 92a of the lens 90 is adjusted.

In the first exemplary embodiment, as shown in FIG. 7, the light emitting thyristors L are divided into four light emitting thyristor groups, i.e., the light emitting thyristor group I (light emitting thyristors L1 through L32), the light emitting thyristor group II (light emitting thyristors L33 through L64), the light emitting thyristor group III (light emitting thyristors L65 through L96), and the light emitting thyristor group IV (light emitting thyristors L97 through L128).

In the case of the light emitting thyristors L “WITHOUT LENS” shown in FIG. 10, the amount of light of the light emitting thyristor L33, which has the smallest light emitting thyristor number in the light emitting thyristor group II, is smaller than that of the light emitting thyristor L1 by about 2%. The amount of light of the light emitting thyristor L65, which has the smallest light emitting thyristor number in the light emitting thyristor group III, is smaller than that of the light emitting thyristor L1 by about 4%. The amount of light of the light emitting thyristor L97, which has the smallest light emitting thyristor number in the light emitting thyristor group IV, is smaller than that of the light emitting thyristor L1 by about 6%. That is, in each light emitting thyristor group, a drop of about 2% occurs in the amount of light.

Conversely, the amount of light of the light emitting thyristor L65 in the light emitting thyristor group III is larger than that of the light emitting thyristor 97 in the light emitting thyristor group IV by about 2%. The amount of light of the light emitting thyristor L33 in the light emitting thyristor group II is larger than that of the light emitting thyristor L65 in the light emitting thyristor group III by about 2%. The amount of light of the light emitting thyristor L1 in the light emitting thyristor group I is larger than that of the light emitting thyristor L33 in the light emitting thyristor group II by about 2%.

In the first exemplary embodiment, the height s is set so that a variation in the amount of light in the overall light emitting thyristors L1 through L128 is 2%. A variation in the amount of light of the light emitting thyristors L shown in FIG. 10 will be discussed with reference to FIG. 11.

The height s4 of the light emitting thyristor group IV is set to be 19 μm (see FIG. 11). It is now assumed that the amount of light of the light emitting thyristor L97, which has the smallest light emitting thyristor L number in the light emitting thyristor group IV is 1. Then, the amount of light of the light emitting thyristor L128, which has the largest light emitting thyristor L number in the light emitting thyristor group IV, is 0.98, which is smaller than that of the light emitting thyristor L97 by about 2%. This is because, in the light emitting thyristor group IV, as in the light emitting thyristors L without the lens 90, as the light emitting thyristor L number increases, the resistance (value) of a portion of the lighting signal 75 (trunk portion 75a) through which a current for turning ON the light emitting thyristor L flows increases.

Then, the height s3 of the light emitting thyristor group III is set to be 16.4 μm (see FIG. 11) so that the amounts of light of the light emitting thyristors L in the light emitting thyristor group III are smaller than those in the light emitting thyristor group IV (height s4 is 19 μm) by about 2%. In the case of the light emitting thyristors L “WITHOUT LENS” shown in FIG. 10, the amount of light of the light emitting thyristor L65, which has the smallest light emitting thyristor L number in the light emitting thyristor group III, is larger by about 2% than that of the light emitting thyristor L97, which has the smallest light emitting thyristor number in the light emitting thyristor group IV. In the case of the light emitting thyristors L “WITH LENS”, however, since the height s3 is different from the height s4, the amount of light of the light emitting thyristor L65 in the light emitting thyristor group III is about the same (value (1)) as that of the light emitting thyristor L97 in the light emitting thyristor group IV.

The amount of light of the light emitting thyristor L96, which has the largest light emitting thyristor L number in the light emitting thyristor group III, is smaller (0.98) by about 2% than that (value (1)) of the light emitting thyristor L65, which has the smallest light emitting thyristor L number in the light emitting thyristor group III.

Further, the height s2 of the light emitting thyristor group II is set to be 15.5 μm (see FIG. 11) so that the amounts of light of the light emitting thyristors L in the light emitting thyristor group II are smaller than those in the light emitting thyristor group III (height s3 is 16.4 μm) by about 2%. In the case of the light emitting thyristors L “WITHOUT LENS” shown in FIG. 10, the amount of light of the light emitting thyristor L33, which has the smallest light emitting thyristor L number in the light emitting thyristor group II, is larger by about 2% than that of the light emitting thyristor L65, which has the smallest light emitting thyristor L number in the light emitting thyristor group III. In the case of the light emitting thyristors L “WITH LENS”, however, since the height s2 is different from the height s3, the amount of light of the light emitting thyristor L33 in the light emitting thyristor group II is about the same (value (1)) as that of the light emitting thyristor L65 in the light emitting thyristor group III.

The amount of light of the light emitting thyristor L64, which has the largest light emitting thyristor L number in the light emitting thyristor group II is smaller (0.98) by about 2% than that (value (1)) of the light emitting thyristor L33, which has the smallest light emitting thyristor L number in the light emitting thyristor group II.

Further, the height s1 of the light emitting thyristor group I is set to be 14.9 ρm (see FIG. 11) so that the amounts of light of the light emitting thyristors L in the light emitting thyristor group I are smaller than those in the light emitting thyristor group II (height s2 is 15.5 μm) by about 2%. In the case of the light emitting thyristors L “WITHOUT LENS” shown in FIG. 10, the amount of light of the light emitting thyristor L1, which has the smallest light emitting thyristor L number in the light emitting thyristor group I, is larger by about 2% than that of the light emitting thyristor L33, which has the smallest light emitting thyristor L number in the light emitting thyristor group II. In the case of the light emitting thyristors L “WITH LENS”, however, since height s1 is different from the height s2, the amount of light of the light emitting thyristor L1 in the light emitting thyristor group I is about the same (value (1)) as that of the light emitting thyristor L63 in the light emitting thyristor group II.

The amount of light of the light emitting thyristor L32, which has the largest light emitting thyristor L number in the light emitting thyristor group I is smaller (0.98) by about 2% than that (value (1)) of the light emitting thyristor L1, which has the smallest light emitting thyristor L number in the light emitting thyristor group I.

In this manner, although there is a variation in the amount of light among the light emitting thyristors L in the same light emitting thyristor group, a variation in the amount of light in the overall light emitting thyristors L can be suppressed. For example, as shown in “WITH LENS” in FIG. 10, a variation in the amount of light among the light emitting thyristors L is reduced from about 8% to about 2%.

FIG. 10 shows that the amounts of light of the light emitting thyristors L “WITH LENS” (L1, L33, L65, and L97) which have the smallest light emitting thyristor L numbers in the individual light emitting thyristor groups are increased to a factor of 2.32 compared with that of the light emitting thyristor L1 “WITHOUT LENS”.

A description has been given, assuming that the amount of light of the light emitting thyristor L linearly changes with respect to the light emitting thyristor L number (position), and that an increase or a decrease in the light amount of the light emitting thyristor L is about 2%. This is an example only. In accordance with a variation in the resistance (value) of portions of the lighting signal line 75 (trunk portion 75a) through which a current for turning ON the light emitting thyristors L flows and in accordance with a variation in the amount of light among the light emitting thyristors L, the height s from the light emitting surface 311 to the vertex 92a of the lens 90, i.e., the thickness of the base 91 (height from the light emitting thyristor L to the boundary between the base 91 and the lens portion 92), is set.

Although in the first exemplary embodiment the light emitting thyristors L are divided into four groups, they may be divided into five or more groups. By dividing the light emitting thyristors L into more groups, it is possible to further reduce a variation (about 2% in this example) in the amount of light among the light emitting thyristors L.

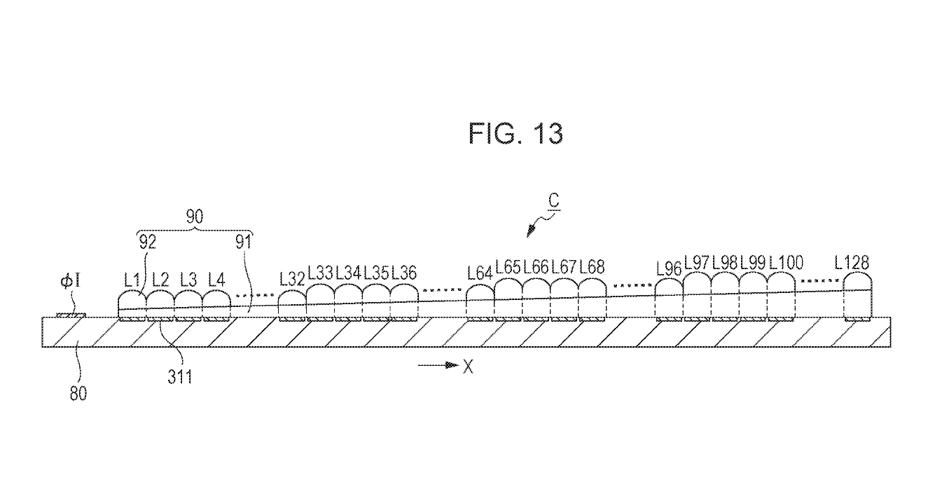

FIG. 13 illustrates the lenses 90 for which the bases 91 are provided such that they are gradually tilted.

In FIG. 13, in order to set the height s in accordance with the amount of light of each of the light emitting thyristors L, the surfaces of the bases 91 (boundaries with the lens portions 92) are tilted. By setting the height s for each light emitting thyristor L, a variation in the amount of light among the light emitting thyristors L is further reduced.

The tilt of degree is set so that a variation in the amount of light among the light emitting thyristors L can be suppressed, by considering the variation in the amount of light among the light emitting thyristors L and the relationship between the amount of light and the height s from the light emitting surface 311 to the vertex 92a of the lens 90 shown in FIG. 11. Accordingly, the surfaces of the bases 91 may be surfaces formed with one angle of tilt, or may be surfaces formed in the shape of a projection or a recess. Alternatively, such forms of surfaces may appear for every group of plural light emitting thyristors L.

Additionally, the surfaces of the bases 91 that face the light emitting surfaces 311 of the light emitting thyristors L may be in parallel with the light emitting surfaces 311. That is, each of the light emitting thyristor groups shown in FIG. 7 may be formed as one light emitting thyristor L.

The lenses 90 having the tilted bases 91 shown in FIG. 13 may be formed by using an imprinting method.

The lens portions 92 of the lenses 90 are formed in a convex shape on a side away from the light emitting surfaces 311. However, the shape of the lenses 90 is not restricted to a convex shape.

FIGS. 14A and 14B illustrate examples of other shapes of the lenses 90. FIG. 14A illustrates lenses 90 having lens portions 92 in which regions corresponding to vertexes 92a are flat (flattened surfaces 92b). FIG. 14B illustrates lenses 90 in which cylindrical apertures 92c are provided from the vertexes (vertexes 92a of the lenses 90 shown in FIGS. 6B and 7) toward the light emitting surfaces 311. In FIG. 14B, regions of the lens portions 92 of the lenses 90 other than the cylindrical apertures 92c are indicated by the hatched portions.

The light emitting surface 311 of the light emitting thyristor L is a plane, and thus, it does not function as a point light source, but functions as a surface light source having a finite area. Then, as in the Lambertian surface light source, the light emitting surface 311 may emit light from miniscule areas (surface elements) forming the light emitting surface 311 such that the luminance can be uniform in all directions. Such a light emitting distribution is a Lambertian distribution. Thus, light emitted in a direction perpendicular to the light emitting surface 311 has a highest level of intensity, and light emitted in directions closer to being parallel with the light emitting surface 311 has a lower level of intensity.

It is thus desirable to extract a greater amount of light emitted in a direction perpendicular to the light emitting surface 311.

Additionally, light emitted from a portion (horseshoe region 311a) around the n-type ohmic electrode 321 (see FIG. 6A) placed at the central portion of the light emitting surface 311 of the light emitting thyristor L has the highest level of intensity, and light emitted from a portion farther away from the center of the light emitting surface 311 has a lower level of intensity.

It is thus desirable to efficiently extract light emitted from the central portion of the light emitting surface 311 having a higher level of intensity.

In order to extract light emitted in a direction perpendicular to the light emitting surface 311 from the central portion of the light emitting surface 311 (in order to input light into a range of an angular aperture θ, it is not always necessary to utilize the function of the lenses. Thus, a region of the lens portion 92 that faces the central portion of the light emitting surface 311 is formed into the flattened surface 92b (FIG. 14A) or the cylindrical aperture 92c (FIG. 14B), thereby enhancing the efficiency in extracting light emitted from the light emitting thyristor L.

In order to efficiently extract highly intensified light emitted from the horseshoe region 311a, a cylindrical lens and/or a spherical lens may be used as the lens portion 92 in accordance with the horseshoe region 311a.

The configurations of the lenses 90 shown in FIGS. 14A and 14B are examples only, and the lenses 90 may be formed into another configuration.

### Second Exemplary Embodiment

In the first exemplary embodiment, as shown in FIG. 5, the light emitting chip C includes a single SLED. In a second exemplary embodiment, a light emitting chip C includes two SLEDs (SLED-l, SLED-r).

The configurations of the image forming apparatus 1 (see FIG. 1), the print head 14 (see FIG. 2), and the light emitting device 65 (see FIG. 3) are similar to those of the first exemplary embodiment. The configurations of the light emitting chips C and the wiring patterns (lines) on the circuit board 62 are different from those of the first exemplary embodiment. Elements different from those of the first exemplary embodiment will be described below while elements similar to those of the first exemplary embodiment will not be described.

### Light Emitting Device 65

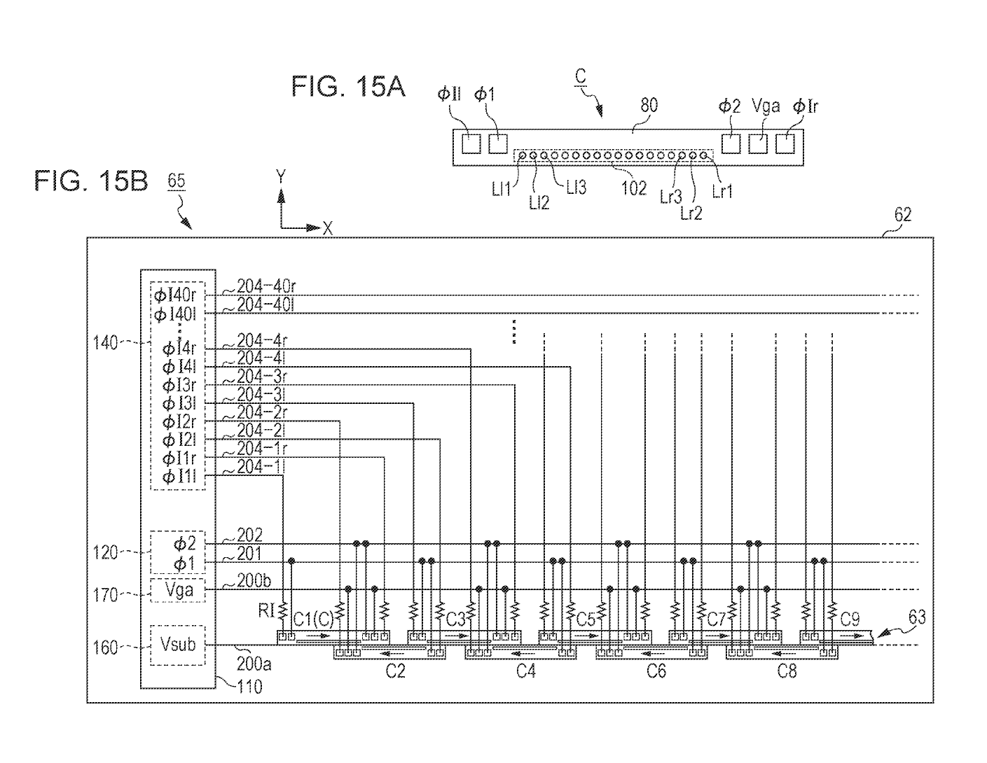

FIG. 15A illustrates the configuration of a light emitting chip C according to the second exemplary embodiment. FIG. 15B illustrates the configuration of the signal generating circuit 110 of the light emitting device 65 and the configuration of the wiring patterns (lines) on the circuit board 62 of the light emitting device 65.

A description will be given only of elements different from the counterparts of the first exemplary embodiment shown in FIGS. 4A and 4B.

A description will first be given of the configuration of the light emitting chip C shown in FIG. 15A.

The light emitting chip C includes a light emitting section 102 on the surface of a substrate 80 which is formed in a rectangular shape as viewed above. The light emitting section 102 is constituted of plural light emitting elements (light emitting thyristors Ll1, Ll2, Ll3, etc. and Lr1, Lr2, Lr3, etc. in this exemplary embodiment) which are substantially linearly disposed along and near one long side of the substrate 80. The light emitting chip C also includes plural terminals (φ1 terminal, φ2 terminal, Vga terminal, φIl terminal, and φIr terminal), which are bonding pads, for receiving various control signals, at both ends of the long sides on the surface of the substrate 80. Concerning the arrangement of those terminals, the φIl and φ1 terminals are disposed in this order from one end of the substrate 80, while the φIr, Vga and φ2 terminals are disposed in this order from the other end of the substrate 80. The light emitting section 102 is disposed between the φ1 and φ2 terminals. That is, the light emitting chip C of the second exemplary embodiment includes the φIl terminal instead of the φI terminal of the light emitting chip C of the first exemplary embodiment shown in FIG. 4A, and also includes the φIr terminal at the other end of the substrate 80.

A description will now be given, with reference to FIG. 15B, of the configuration of the signal generating circuit 110 and the configuration of the wiring patterns (lines) on the circuit board 62.

In the second exemplary embodiment, as well as in the first exemplary embodiment, the signal generating circuit 110 and the light emitting chips C1 through C40 are mounted on the circuit board 62 of the light emitting device 65. Wiring patterns (lines) for connecting the signal generating circuit 110 and the light emitting chips C1 through C40 are also provided.

In the signal generating circuit 110, the configuration of the lighting signal generator 140 is different from that of the first exemplary embodiment. That is, in the second exemplary embodiment, two lighting signals φI1l and φI1r are utilized instead of the lighting signal φI1 in the first exemplary embodiment. The other lighting signals φI2 through φI40 are also expressed in the same way. When the lighting signals φI1l through φI40l are not distinguished from one another, they are simply referred to as the “lighting signal φIl”. When the lighting signals φI1r through φI40r are not distinguished from one another, they are simply referred to as the “lighting signal φIr”. When the lighting signal φIl and the lighting signal φIr are not distinguished from each other, they are simply referred to as the “lighting signal φI”.

The other portions of the configuration of the signal generating circuit 110 are similar to those of the first exemplary embodiment.

Concerning the wiring patterns (lines) for connecting the signal generating circuit 110 and the light emitting chips C1 through C40, portions different from those of the first exemplary embodiment will be discussed below.

On the circuit board 62, lighting signal lines 204-1l through 204-40l are provided. Through the lighting signal lines 204-1l through 204-40l, the lighting signal generator 140 of the signal generating circuit 110 transmits lighting signals φI1l through φI40l, respectively, to the φIl terminals of the light emitting chips C1 through C40 via the corresponding current regulating resistors RI. Similarly, on the circuit board 62, lighting signal lines 204-1r through 204-40r are provided. Through the lighting signal lines 204-1r through 204-40r, the lighting signal generator 140 of the signal generating circuit 110 transmits lighting signals φI1r through φI40r, respectively, to the φIr terminals of the light emitting chips C1 through C40 via the corresponding current regulating resistors RI.

That is, the different lighting signals φI1l through φI40l are supplied to the φIl terminals of the corresponding light emitting chips C, and the different lighting signals φI1r through φI40r are supplied to the φIr terminals of the corresponding light emitting chips C.

The other wiring patterns (lines) are similar to those of the first exemplary embodiment.

As described above, the reference potential Vsub and the power supply potential Vga are supplied to all the light emitting chips C1 through C40 on the circuit board 62. The first and second transfer signals φ1 and φ2 are also transmitted (in parallel) to all the light emitting chips C1 through C40. In contrast, the lighting signals φI1l through φI40l are individually supplied to the φIl terminals of the light emitting chips C1 through C40, respectively, and the lighting signals φI1r through φI40r are individually supplied to the φIr terminals of the light emitting chips C1 through C40, respectively.

As in the first exemplary embodiment, the light emitting device 65 may not include the signal generating circuit 110. In this case, the power supply lines 200a and 200b, the first and second transfer lines 201 and 202, and the lighting signal lines 204-1l through 204-40l and 204-1r through 204-40r are connected to a connector instead of the signal generating circuit 110. Then, the light emitting device 65 is connected to the signal generating circuit 110 which is externally disposed by using this connector via a cable.

### Light Emitting Chip C

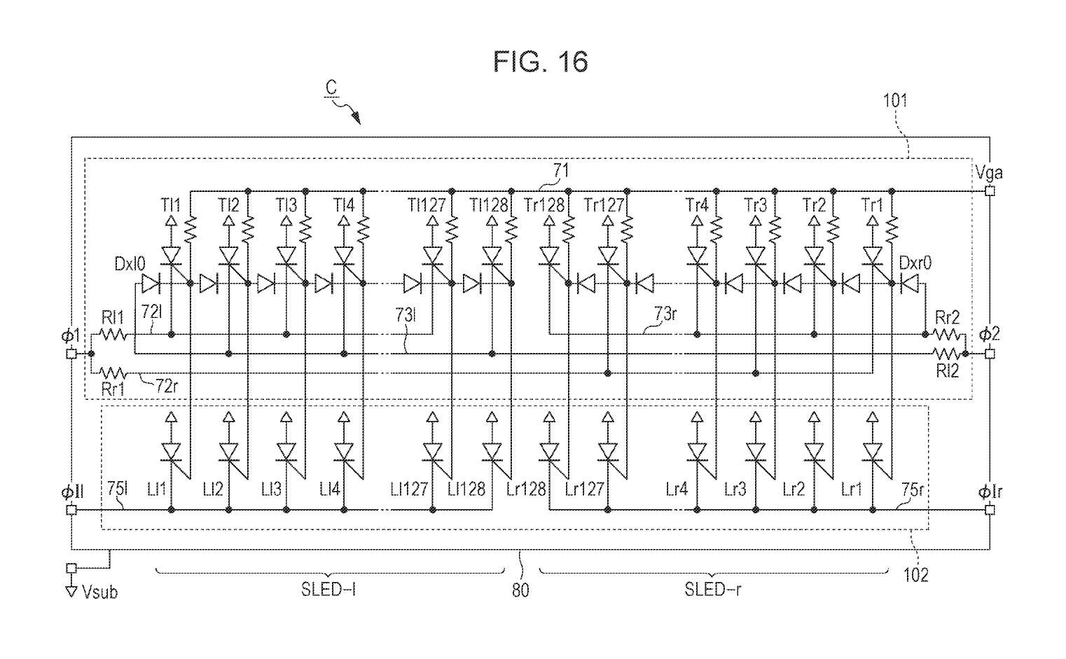

FIG. 16 is an equivalent circuit diagram illustrating the circuit configuration of the light emitting chip C of the second exemplary embodiment on which two SLEDs (SLED-l, SLED-r) are mounted. SLED-l is disposed on the left side of the light emitting chip C, while SLED-r is disposed on the right side of the light emitting chip C. In accordance with the arrangement of the terminals shown in FIG. 14A, the φ1 terminal and the φIl terminal are arranged on the left side of the light emitting chip C, while the Vga terminal, the φ2 terminal, and the φIr terminal are arranged on the right side of the light emitting chip C.

In FIG. 16, the relationship of the terminals to the signal generating circuit 110 is not shown, and thus, the light emitting chips C1 through C40 will be discussed as the light emitting chip C. The configurations of the light emitting chips C1 through C40 are the same as the configuration of the light emitting chip C.

The configuration of the SLED-l is similar to that of the SLED of the first exemplary embodiment shown in FIG. 5. Concerning the SLED-r, if the SLED-l is horizontally inverted in the plane of FIG. 16 and is disposed on the right side of the SLED-l, the SLED-r is obtained. Accordingly, a description will be given only of portions of the SLED-l and SLED-r different from those of the SLED shown in FIG. 5.

The SLED-l includes 128 light emitting thyristors Ll1 through Ll128 substantially linearly disposed on the substrate 80. The SLED-l also includes transfer thyristors Tl1 through Tl128 corresponding to the light emitting thyristors Ll1 through Ll128, respectively. When the light emitting thyristors Ll1 through Ll128 are not distinguished from one another, they are simply referred to as the “light emitting thyristor Ll, and when the transfer thyristors Tl1 through Tl128 are not distinguished from one another, they are simply referred to as the “transfer thyristor Tl.

The light emitting thyristor L1 and the transfer thyristor Tl designated by the same numbers correspond to each other, and they are arranged in ascending order from the left to the right in FIG. 16.

The SLED-r includes 128 light emitting thyristors Lr1 through Lr128 substantially linearly disposed on the substrate 80. The SLED-r also includes transfer thyristors Tr1 through Tr128 corresponding to the light emitting thyristors Lr1 through Lr128, respectively. When the light emitting thyristors Lr1 through Lr128 are not distinguished from one another, they are simply referred to as the “light emitting thyristor Lr, and when the transfer thyristors Tr1 through Tr128 are not distinguished from one another, they are simply referred to as the “transfer thyristor Tr.

The light emitting thyristor Ll and the transfer thyristor Tl designated by the same numbers correspond to each other, and they are arranged in ascending order from the right to the left in FIG. 16.

The interval between the light emitting thyristor Lr128 of the SLED-r and the light emitting thyristor Ll128 of the SLED-l is equal to the interval among the light emitting thyristors Ll1 through Ll128 (or light emitting thyristors Lr1 through Lr128).

Adjacent transfer thyristors Tl are connected to each other with a corresponding coupling diode (no reference numerals), and adjacent transfer thyristors Tr are connected to each other with a corresponding coupling diode (no reference numerals). The coupling diodes are connected to one another in the direction in which a current flows from a coupling diode designated by a smaller number to a coupling diode designated by a larger number.

The SLED-l and the SLED-r include start diodes Dx10 and Dxr0, respectively. The cathode terminal of the start diode Dx10 is connected to the gate terminal of the transfer thyristor Tl1, and the anode terminal thereof is connected to a second transfer signal line 731 connected to the φ2 terminal. Meanwhile, the cathode terminal of the start diode Dxr0 is connected to the gate terminal of the transfer thyristor Tr1, and the anode terminal thereof is connected to a second transfer signal line 73r connected to the φ2 terminal.

The cathode terminals of the odd-numbered transfer thyristors Tl1, T13, etc. are connected to the φ1 terminal via a current regulating resistor R11. The cathode terminals of the odd-numbered transfer thyristors Tr1, Tr3, etc. are connected to the φ1 terminal via a current regulating resistor Rr1.

Similarly, the cathode terminals of the even-numbered transfer thyristors T12, T14, etc. are connected to the φ2 terminal via a current regulating resistor R12. The cathode terminals of the even-numbered transfer thyristors Tr2, Tr4, etc. are connected to the φ2 terminal via a current regulating resistor Rr2.

The cathode terminals of the light emitting thyristors Ll1 through Ll128 are connected to a lighting signal line 75l. The lighting signal line 75l is connected to the φIl terminal. The lighting signal φIl is transmitted from the lighting signal generator 140 to the φIl terminal. By transmitting the lighting signal φIl, a current for turning ON the light emitting thyristors Ll1 through Ll128 is supplied to the light emitting thyristors Ll1 through Ll128.

The cathode terminals of the light emitting thyristors Lr1 through Lr128 are connected to a lighting signal line 75r. The lighting signal line 75r is connected to the φIr terminal. The lighting signal φIr is transmitted from the lighting signal generator 140 to the φIr terminal. By transmitting the lighting signal φIr, a current for turning ON the light emitting thyristors Lr1 through Lr128 is supplied to the light emitting thyristors Lr1 through Lr128.

In the SLED-l of the light emitting chip C, the path in the lighting signal line 75l (corresponding to the trunk portion 75a in FIG. 6A) through which the lighting signal φIl flows becomes longer and farther from the φIl terminal as the light emitting thyristor Ll number becomes greater.

In the SLED-r of the light emitting chip C, too, the path in the lighting signal line 75r (corresponding to the trunk portion 75a in FIG. 6A) through which the lighting signal φIr flows becomes longer and farther from the φIr terminal as the light emitting thyristor Lr number becomes greater.

As described above, in the light emitting chip C of the second exemplary embodiment, the first transfer signal φ1 and the second transfer signal φ2 are transmitted to both the SLED-l and the SLED-r so as to cause the SLED-l and the SLED-r to operate in parallel. In contrast, the lighting signal φIl and φIr are separately transmitted to the SLED-l and the SLED-r, respectively.

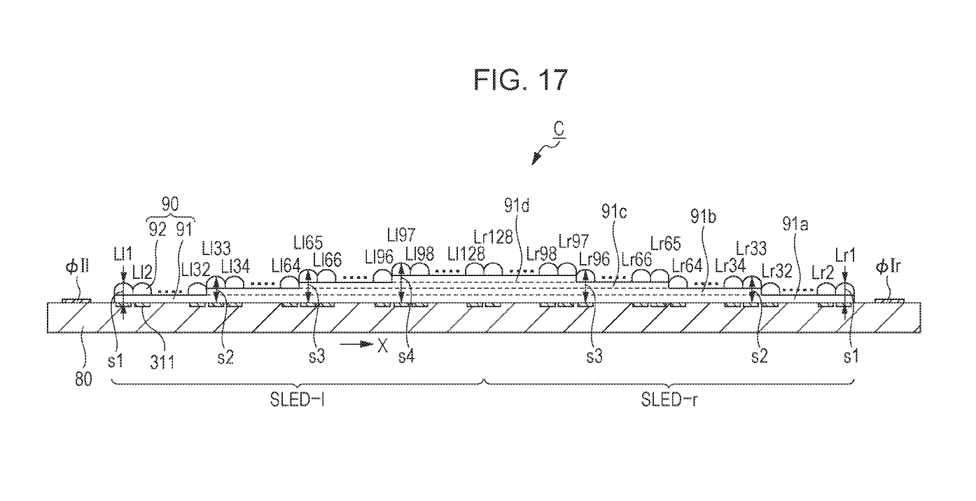

FIG. 17 illustrates lenses 90 (including bases 91 and lens portions 92) provided on the light emitting thyristors L according to the second exemplary embodiment.

In each of the SLED-l and the SLED-r of the light emitting chip C, as in the first exemplary embodiment, the height s from the light emitting surface 311 to the vertex 92a of the lens 90 is changed by four levels (s1 through s4). The height s1 is the smallest, and the heights s2, s3, and s4 become larger in ascending order (s1<s2<s3<s4). The height s of the light emitting thyristor Ll1 closest to the φIl terminal is set to be the height s1, and the height s of the light emitting thyristor Ll128 farthest from the φIl terminal is set to be the height s4. Similarly, the height s of the light emitting thyristor Lr1 closest to the φIr terminal is set to be the height s1, and the height s of the light emitting thyristor Lr128 farthest from the φIr terminal is set to be the height s4.

That is, in the lenses 90 shown in FIG. 17, the SLED-l is similar to the SLED shown in FIG. 7, and concerning the SLED-r, if the SLED-l is horizontally inverted in the plane of FIG. 17, the SLED-r is obtained.

As described above, in the second exemplary embodiment, the light emitting chip C includes a light emitting thyristor array (light emitting section 102, see FIG. 15A)) constituted of the light emitting thyristors Ll1 through Ll128 and the light emitting thyristors Lr1 through Lr128. The light emitting chip C also includes a transfer section 101 (see FIG. 16) constituted of the transfer thyristors Tl1 through Tl128, the transfer thyristors Tr1 through Tr128, the coupling diodes, the power supply line resistors, the start diodes Dx10 and Dxr0, and the current regulating resistors R11, Rr1, R12, and Rr2.

As described above, in the light emitting chip C of the second exemplary embodiment, by adding one more terminal (φIr terminal) to the light emitting chip C of the first exemplary embodiment, the number of light emitting thyristors is doubled from 128 to 256. Accordingly, if the number (i.e., 40) of light emitting chips C is not changed, the number of light emitting elements (dots) in the main scanning direction is doubled. In contrast, if the number of light emitting elements (dots) in the main scanning direction is not changed, the number of light emitting chips C is halved (e.g., 20).

The light emitting chip C of the second exemplary embodiment is manufactured in a manner similar to that of the first exemplary embodiment.

The operation of the light emitting chip C will be discussed below.

A description will now be given by taking the light emitting chip C1 as an example. As stated above, the light emitting chips C1 through C40 are operated in parallel.

The operation of the SLED-l of the light emitting chip C1 is similar to that of the light emitting chip C of the first exemplary embodiment, and thus, in FIG. 9, the lighting signal φI1l is utilized instead of the lighting signal φI1.

The SLED-r of the light emitting chip C is operated in parallel with the SLED-l. That is, the first transfer signal φ1 and the second transfer signal φ2 are transmitted to both the SLED-l and the SLED-r, thereby causing the transfer thyristors Tl and Tr designated by the same number to be turned ON in parallel.

Then, the ON/OFF operations of the light emitting thyristors Ll and Lr connected to the ON-state transfer thyristors Tl and Tr, respectively, are controlled by the lighting signals φIl and φIr which are transmitted separately. If the lighting signal φIl is at “L”, the light emitting thyristor Ll is turned ON, and if the lighting signal φIl is at “H”, the light emitting thyristor Ll remains OFF. Similarly, if the lighting signal φIr is at “L”, the light emitting thyristor Lr is turned ON, and if the lighting signal φIr is at “H”, the light emitting thyristor Lr remains OFF.

As stated above, in the plane of FIG. 16, the transfer thyristors Tl and the light emitting thyristors Ll are arranged from the left to the center of the light emitting chip C, while the transfer thyristors Tr and the light emitting thyristors Lr are arranged from the right to the center of the light emitting chip C. Accordingly, the ON/OFF operations of the light emitting thyristors L1 of the SLED-l are controlled in a direction from the left to the center of the light emitting thyristors Ll, while the ON/OFF operations of the light emitting thyristors Lr of the SLED-r are controlled in a direction from the right to the center of the light emitting thyristors Lr.

Details of the operation of the light emitting chip C1 are similar to those of the first exemplary embodiment, and thus, a further explanation thereof will not be given. The light emitting chip C1 is operated as described above.

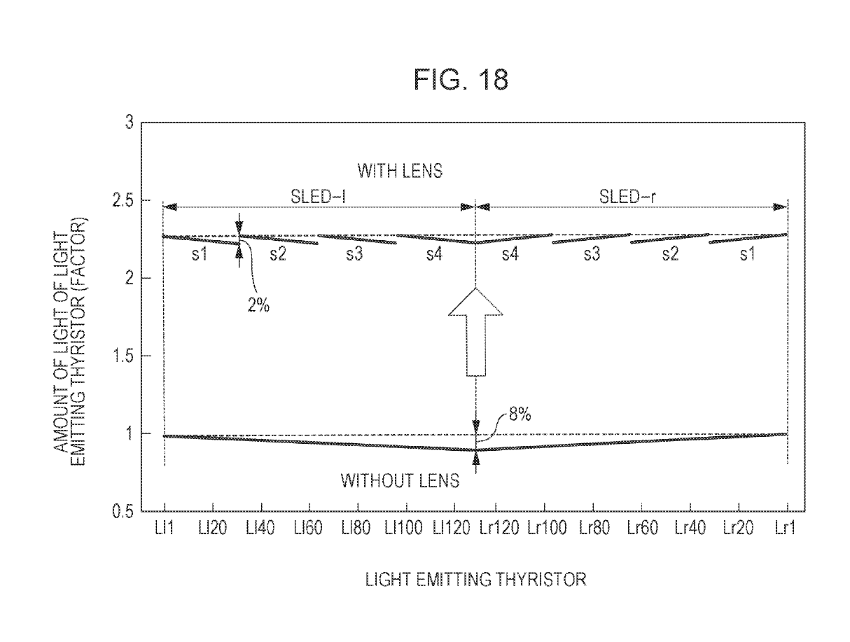

FIG. 18 illustrates the amounts of light of the light emitting thyristors L of the light emitting chip C according to the second exemplary embodiment. The amounts of light of the light emitting thyristors L are expressed by numerical values, assuming that the amount of light of the light emitting thyristor L1 “WITHOUT LENS” is 1. It is also assumed that the amount of light of the light emitting thyristor Lr is 1.

In the second exemplary embodiment, as well as in the first exemplary embodiment, concerning the light emitting thyristors “WITHOUT LENS”, as the light emitting thyristor L numbers increase the paths in the lighting signal lines 75l and 75r through which currents flow become longer, thereby increasing the influence of a voltage drop due to the resistances of the paths in the light signal lines 75l and 75r. The amounts of light of the light emitting thyristors Ll and Lr gradually decrease as the light emitting thyristor L numbers increase. That is, the amount of light at the center of the light emitting chip C is the smallest (e.g., it is smaller than the amounts of light at both ends of the light emitting chip C by 8%).

Accordingly, in the second exemplary embodiment, the light emitting chips C are provided with the lenses 90 (bases 91 and lens portions 92) (see FIG. 17). Then, the height s from the light emitting surface 311 to the vertex 92a of the lens 90 is increased as the light emitting thyristor Ll number and the light emitting thyristor Lr number increase. Thus, the occurrence of a variation in the amount of light of each group of the light emitting thyristors Ll and the light emitting thyristors Lr is suppressed. That is, the occurrence of a variation in the amount of light of the overall light emitting chip C can be suppressed.

In the second exemplary embodiment, as discussed in the first exemplary embodiment with reference to FIG. 13, the base 91 may be tilted. In this case, in the SLED-l, the height s increases in a direction from the light emitting thyristor Ll1 to the light emitting thyristor Ll128. In the SLED-r, the height s increases in a direction from the light emitting thyristor Lr1 to the light emitting thyristor Lr128.

Concerning the configuration of the lenses 90, the flattened surfaces 92b or the cylindrical apertures 92c, as shown in FIGS. 14A and 14B, respectively, may be provided. Alternatively, the lenses 90 may be configured other than that shown in FIG. 14A or 14B.

Although in FIG. 16 the lighting signal lines 75l and 75r are not connected to each other, they may be connected to each other at a portion between the light emitting thyristors Ll128 and Lr128.

In the first and second exemplary embodiments, the transfer thyristors T and the light emitting thyristors L are common anode thyristors in which the anode terminals are connected to the substrate 80. However, by changing the polarity of the circuit, the transfer thyristors T and the light emitting thyristors L may be common cathode thyristors in which the cathode terminals are connected to the substrate 80.

Moreover, the n-type ohmic electrode 321 is disposed at the center of the light emitting surface 311 of the light emitting thyristor L. However, the n-type ohmic electrode 321 may be displaced from the center of the light emitting surface 311.

Alternatively, the n-type ohmic electrode 321 may not be disposed.

In the first and second exemplary embodiments, a SLED including light emitting thyristors L and transfer thyristors T is utilized. However, the SLED may include, not only light emitting thyristors L and transfer thyristors T, but also control thyristors, and/or other components, e.g., diodes and resistors.

In the first and second exemplary embodiments, the coupling diodes Dx are utilized for connecting the transfer thyristors T with one another. However, another component that can transmit a change in the potential, such as resistors, may be utilized instead of the coupling diodes Dx.

In the first and second exemplary embodiments, light emitting thyristors are utilized as light emitting elements. However, light emitting diodes (LEDs) formed by stacking a p-type semiconductor layer and an n-type semiconductor layer may be utilized.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting unit comprising:
a substrate;
a plurality of light emitting elements disposed on the substrate; and
a lens array disposed above the plurality of light emitting elements, the lens array including
a plurality of lenses that each focus light emitted from a corresponding light emitting element among the plurality of light emitting elements, and
a base including a boundary surface which is in contact with the plurality of lenses and an opposing surface which opposes the plurality of light emitting elements,
wherein a distance from one of the plurality of light emitting elements to the boundary surface of the base which is in contact with a corresponding lens among the plurality of lenses is different from a distance from another one of the plurality of light emitting elements to the boundary surface of the base which is in contact with a corresponding lens among the plurality of lenses.

2. The light emitting unit according to claim 1, wherein the boundary surface of the base has a step-like shape including a plurality of steps, and the one of the plurality of lenses and the another one of the plurality of lenses are in contact with the different steps.

3. The light emitting unit according to claim 2, wherein the one of the plurality of lenses comprises two or more of the plurality of lenses which are in contact with one of the plurality of steps.

4. The light emitting unit according to claim 1, wherein:
the plurality of light emitting elements are arranged in a predetermined direction on the substrate; and
the boundary surface of the base has a tilted surface with respect to the opposing surface of the base, the tilted surface being tilted in the direction in which the plurality of light emitting elements are arranged, and each of the plurality of lenses is in contact with the tilted surface.

5. The light emitting unit according to claim 1, wherein the distances from the plurality of light emitting elements to the boundary surface of the base differ in accordance with amounts of light emitted from the plurality of corresponding light emitting elements.

6. The light emitting unit according to claim 1, wherein the distance from one of the plurality of light emitting elements that emits a larger amount of light to the boundary surface of the base is smaller than the distance from another one of the plurality of light emitting elements that emits a smaller amount of light to the boundary surface of the base.

7. The light emitting unit according to claim 1, further comprising:
an electrode; and
a plurality of lines disposed on the substrate, the plurality of lines connecting the electrode and the plurality of light emitting elements,
wherein the distances from the plurality of light emitting elements to the boundary surface of the base differ in accordance with lengths of the plurality of lines.

8. The light emitting unit according to claim 1, further comprising:
an electrode; and
a plurality of lines disposed on the substrate, the plurality of lines connecting the electrode and the plurality of light emitting elements,
wherein the distances from the plurality of light emitting elements to the boundary surface of the base differ in accordance with resistances of the plurality of lines.

9. The light emitting unit according to claim 1, wherein the plurality of light emitting elements are a plurality of light emitting thyristors,
the light emitting unit further comprising:
transfer thyristors which are integrated together with the plurality of light emitting thyristors so as to perform control so that the plurality of light emitting thyristors sequentially emit light in order to scan the emitted light.

10. An image forming apparatus comprising:
an image carrier;
a charging device that charges the image carrier;
a light emitting unit that exposes the image carrier charged by the charging device to light;
a developing unit that develops an electrostatic latent image formed on the image carrier as a result of allowing the image carrier to be exposed to light by using the light emitting unit; and
a transfer unit that transfers, onto a transfer medium, an image formed on the image carrier as a result of developing the electrostatic latent image by using the developing unit,
the light emitting unit including
a substrate,
a plurality of light emitting elements disposed on the substrate, and
a lens array disposed above the plurality of light emitting elements, the lens array including
a plurality of lenses that each focus light emitted from a corresponding light emitting element among the plurality of light emitting elements, and
a base including a boundary surface which is in contact with the plurality of lenses and an opposing surface which opposes the plurality of light emitting elements,
wherein a distance from one of the plurality of light emitting elements to the boundary surface of the base which is in contact with a corresponding lens among the plurality of lenses is different from a distance from another one of the plurality of light emitting elements to the boundary surface of the base which is in contact with a corresponding lens among the plurality of lenses.

11. The image forming apparatus according to claim 10, wherein the boundary surface of the base has a step-like shape including a plurality of steps, and the one of the plurality of lenses and the another one of the plurality of lenses are in contact with the different steps.

12. The image forming apparatus according to claim 11, wherein the one of the plurality of lenses comprises two or more of the plurality of lenses which are in contact with one of the plurality of steps.

13. The image forming apparatus according to claim 10, wherein:
the plurality of light emitting elements are arranged in a predetermined direction on the substrate; and
the boundary surface of the base has a tilted surface with respect to the opposing surface of the base, the tilted surface being tilted in the direction in which the plurality of light emitting elements are arranged, and each of the plurality of lenses is in contact with the tilted surface.

14. The image forming apparatus according to claim 10, wherein the distances from the plurality of light emitting elements to the boundary surface of the base differ in accordance with amounts of light emitted from the plurality of corresponding light emitting elements.

15. The image forming apparatus according to claim 10, wherein the distance from one of the plurality of light emitting elements that emits a larger amount of light to the boundary surface of the base is smaller than the distance from another one of the plurality of light emitting elements that emits a smaller amount of light to the boundary surface of the base.

16. The image forming apparatus according to claim 10, wherein the light emitting unit further includes
an electrode, and
a plurality of lines disposed on the substrate, the plurality of lines connecting the electrode and the plurality of light emitting elements,
wherein the distances from the plurality of light emitting elements to the boundary surface of the base differ in accordance with lengths of the plurality of lines.

17. The image forming apparatus according to claim 10, wherein the light emitting unit further includes
an electrode, and
a plurality of lines disposed on the substrate, the plurality of lines connecting the electrode and the plurality of light emitting elements,
wherein the distances from the plurality of light emitting elements to the boundary surface of the base differ in accordance with resistances of the plurality of lines.

18. The image forming apparatus according to claim 10, wherein the plurality of light emitting elements are a plurality of light emitting thyristors,
the light emitting unit further includes
transfer thyristors which are integrated together with the plurality of light emitting thyristors so as to perform control so that the plurality of light emitting thyristors sequentially emit light in order to scan the emitted light.
